(19) United States
(12) Patent Application Publication
(10) Pub. No.: US 2009/0259789 A1
(43) Pub. Date: Oct. 15, 2009

(54) MULTI-PROCESSOR, DIRECT MEMORY ACCESS CONTROLLER, AND SERIAL DATA TRANSMITTING/RECEIVING APPARATUS

(76) Inventors: Shuhei Kato, Shiga (JP); Koichi Sano, Shiga (JP); Koichi Usami, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/064,179

(22) PCT Filed: Aug. 21, 2006
(86) PCT No.: PCT/JP2006/316787

§ 371 Date: Feb. 18, 2009

(30) Foreign Application Priority Data
Aug. 22, 2005 (JP) 2005-239533
Sep. 1, 2005 (JP) 2005-253203
Nov. 1, 2005 (JP) 2005-318902

(51) Int. Cl. G06F 13/28; G06F 13/36; G06F 3/00; G06F 13/362

(52) U.S. Cl. 710/308; 711/154; 710/52; 710/113; 711/E12.001

(57) ABSTRACT

A CPU 5 is provided with both the functionality of issuing an external bus access request directly to an external memory interface 3 and the functionality of issuing a DMA transfer request to a DMAC 4. Accordingly, in the case where data is randomly accessed at discrete addresses, an external bus access request is issued directly to the external memory interface 3, and in the case of data block transfer or page swapping as requested by a virtual memory management unit or the like, a DMA transfer request is issued to the DMAC 4, so that it is possible to effectively access the external memory 50.

### TECHNICAL FIELD

The present invention relates to a multiprocessor having a plurality of processor cores, a direct memory access controller, a serial data transmitting and receiving device for transmitting and receiving serial data and the related arts.

### BACKGROUND ART

The multiprocessor disclosed in Japanese Patent Published Application No. Hei 11-175398 (referred to herein as “Patent document 1”) performs data transfer between an external memory and an internal memory by DMA.

The multiprocessor disclosed in Japanese Patent Published Application No. 2001-51958 (referred to herein as “Patent document 2”) is provided with a memory management unit for each processor core for accessing an external memory.

Generally speaking, the prior art multiprocessor makes use of the same bus for accessing a shared internal memory and for controlling other function units through the CPU.

While the multiprocessor of the Patent document 1 can perform a high speed data transfer by DMA transfer when data is block-transferred between an external memory and an internal memory, the efficiency of the DMA transfer is decreased when data access is randomly performed at discrete addresses.

Since the multiprocessor of the Patent document 2 is implemented with the memory management units respectively provided for the processor cores, the circuit configuration becomes complicated, and it is difficult to reduce the cost.

In the case of the above prior art multiprocessors which make use of the same bus for accessing a shared internal memory and for controlling other function units through the CPU, the access operation of the CPU for controlling the other function units wastes the bus bandwidth of the internal memory.

Accordingly, it is an object of the present invention to provide a multiprocessor and the related arts in which it is possible to effectively access an external memory.

In addition, it is another object of the present invention to provide a multiprocessor and the related arts in which it is possible to simplify the circuit configuration for accessing an external memory and thereby reduce the cost.

Furthermore, it is a further object of the present invention to provide a multiprocessor and the related arts in which it is possible to prevent wasting the bus bandwidth of the internal memory while controlling the processor cores.

Incidentally, the processor described in Japanese Patent Published Application No. 2001-297006 (referred to herein as “Patent document 3”) is provided with a CPU for performing arithmetic operations, an embedded RAM which can be accessed by the CPU for accessing data, an decompression circuit for decompressing compressed data, a DMA controller, and a selector for making a selection as to whether the data to be expanded on the embedded RAM is transferred to the embedded RAM directly or through the decompression circuit, and these elements are formed within a single semiconductor substrate.

The data is divided into blocks each of which contains either compressed data or non-compressed data. The CPU issues a DMA transfer request to the DMA controller for each block. Accordingly, one block is DMA transferred by one DMA transfer request. In other words, compressed data and non-compressed data cannot be mixed in the block which can be transferred by one DMA transfer request.

Accordingly, it is a further object of the present invention to provide a direct memory access controller and the related arts in which the block containing compressed data and the block containing non-compressed data can be mixed in a group of blocks which can be transferred in response to one Direct memory access transfer request.

Incidentally, a computer system provided with an input/output controller having a serial port is introduced in non-patent document 1.

This non-patent document 1 is David A. Patterson and John L. Hennessy, “Computer Organization & Design (Latter Part)”, 2nd Edition, translated by Mitsuaki Narita, Nikkei BP, May 17, 1999, p. 639 and p. 640.

However, the non-patent document 1 does not disclose the specific procedure of transmission and reception by the input/output controller.

Therefore, it is a still further object of the present invention to provide a serial data transmitting and receiving device and the related arts capable of effectively exchanging transmission and reception data with other function unit, contributing to the decrease in the processing load on the other function unit, and making effective use of a shared resource.

### DISCLOSURE OF INVENTION

In accordance with a first aspect of the present invention, a multiprocessor capable of accessing an external bus, comprises: a plurality of processor cores each of which is operable to perform an arithmetic operation; an internal memory which is shared by said plurality of processor cores; a direct memory access controller operable to perform arbitration among direct memory access transfer requests issued by part or all of said processor cores, and perform direct memory access transfer between said internal memory and an external memory which is connected to the external bus; and an external memory interface operable to perform arbitration among requests for using the external bus issued by part or all of said processor cores and said direct memory access controller, and permit one of said processor cores and said direct memory access controller to access the external bus.

In accordance with this configuration, part or all of the processor cores are provided with both the functionality of issuing an external bus access request directly to the external memory interface and the functionality of issuing a direct memory access transfer request to the direct memory access controller. Accordingly, in the case where data is randomly accessed at discrete addresses, an external bus use request is issued directly to the external memory interface, and in the case of data block transfer or page swapping as requested by a virtual memory management unit or the like, a direct memory access transfer request is issued to the direct memory access controller so that it is possible to effectively access the external memory.

In the above multiprocessor, said direct memory access controller comprises: a plurality of buffers each of which is operable to store the direct memory access transfer request issued from a corresponding one of said processor cores; an arbitration unit operable to perform arbitration among a plurality of the direct memory access transfer requests which are output from a plurality of said buffers, and output one of the direct memory access transfer requests; a queue operable to hold a plurality of the direct memory access transfer requests, and output the direct memory access transfer requests output from said arbitration unit in the order of reception; and a direct memory access transfer processing unit operable to perform direct memory access transfer in response to the direct memory access transfer requests output from said queue.

In accordance with this configuration, there are a plurality of buffers and a queue for holding a plurality of direct memory access transfer requests from a plurality of processor cores. Accordingly, even during performing direct memory access transfer, another direct memory access transfer request can be accepted. Particularly, this is effective in the case where there is only one direct memory access channel.

In this multiprocessor, said external memory interface performs arbitration in accordance with a priority level table in which are determined priority levels of said processor cores and said direct memory access controller which can issue requests for using the external bus, wherein, as the priority level table, there is a plurality of priority level tables having different priority levels.

In accordance with this configuration, since the priority levels are not fixed, even if a processor core is given a low priority level as set in a priority level table, a higher priority level can be given to this processor core in other priority level table, and therefore it is avoided that this processor core waits for such a long time after issuing an external bus use request as there occurs shortcomings in the system. This is true for the direct memory access controller.

In this multiprocessor, said external memory interface performs the arbitration by switching the priority level table when a predetermined condition is satisfied.

In accordance with this configuration, it is possible to switch the priority level table in accordance with the purpose by setting the predetermined condition appropriate for this purpose.

The predetermined condition is that a predetermined processor core of said processor cores or said direct memory access controller waits for a predetermined time after issuing a request for using the external bus.

In accordance with this configuration, it is avoided that the predetermined processor core or the direct memory access controller waits for such a long time after issuing an external bus use request as there occurs shortcomings in the system.

Said external memory interface includes a control register which can be accessed by at least one of said processor cores, and switches the priority level table under an additional condition that the control register is set to a predetermined value by the one of said processor cores.

In accordance with this configuration, it is possible to dynamically make a setting as to whether arbitration is performed by fixedly using only one priority level table or switchingly using one of a plurality of priority level tables.

In accordance with the second aspect of the present invention, a multiprocessor is capable of accessing an external bus, and comprises: a plurality of processor cores each of which is operable to perform an arithmetic operation; and an external memory interface operable to perform arbitration among requests for using the external bus issued by part or all of said processor cores, and permit one of said processor cores to access the external bus, wherein said external memory interface includes a plurality of different memory interfaces, and wherein one of the plurality of different memory interfaces is selected to access, through the memory interface as selected, an external memory which is connected to the external bus and belongs to a type supported by the memory interface as selected.

In accordance with this configuration, the mechanism for accessing the external memory is provided with an external memory interface. Accordingly, even in the case where different types of memory interfaces are supported, each of the processor cores need not be provided with a plurality of memory interfaces. Because of this, it is possible to simplify the circuit configuration and reduce the cost.

In this multiprocessor, the address space of the external bus is divided into a plurality of areas each of which can be set in terms of the type of the external memory, wherein said external memory interface selects a memory interface which supports the type of the external memory allocated for one of the areas including the address issued by the processor core that is permitted to access the external bus, and accesses the external memory through the memory interface as selected.

In accordance with this configuration, since each area of the address spaces of the external bus can be set in terms of the type of the external memory, it is possible to connect with a plurality of different types of external memory.

In this multiprocessor, said external memory interface includes a plurality of first control registers corresponding respectively to the plurality of areas, wherein at least one of said processor cores can access the plurality of first control registers, wherein, by setting a value in one of the first control registers through the at least one of said processor cores, a type of the external memory can be allocated for the area corresponding to the one of first control registers.

In accordance with this configuration, it is possible to dynamically set the areas respectively in terms of the type of the external memory through the processor core.

In this multiprocessor, the address space of the external bus is divided into a plurality of areas each of which can be set in terms of the data bus width of the external memory. In accordance with this configuration, a plurality of external memories having different data bus widths can be connected.

In this multiprocessor, said external memory interface includes a plurality of second control registers corresponding to the plurality of areas, wherein the plurality of second control registers can be accessed by at least one processor core, and wherein by setting a value in one of the second control registers through the at least one processor core, a data bus width of the external bus can be set in the area corresponding to the one of second control registers.

In accordance with this configuration, it is possible to dynamically set the areas respectively in terms of the data bus width of the external memory through the processor core.

In this multiprocessor, the address space of the external bus is divided into a plurality of areas each of which can be set in terms of the timing for accessing the external memory. In accordance with this configuration, a plurality of external memories having different access timings can be connected.

In this multiprocessor, said external memory interface includes a plurality of third control registers corresponding respectively to the plurality of areas, wherein at least one of said processor cores can access the plurality of third control registers, and wherein, by setting a value in one of the third control registers through the at least one of said processor cores, a timing for accessing the external memory can be set for the area corresponding to the one of the third control registers.

In accordance with this configuration, it is possible to dynamically set the areas respectively in terms of the timing for accessing the external memory through the processor core.

In the above multiprocessor, said external memory interface includes a fourth control register which can be accessed by at least one of said processor cores, wherein the boundary of the areas can be set by setting a value in the fourth control register through the at least one of said processor cores. In accordance with this configuration, it is possible to dynamically set the boundary between the areas through the processor core.

In accordance with a third aspect of the present invention, a multiprocessor comprises: a plurality of processor cores each of which is operable to perform an arithmetic operation; an internal memory which is shared by said plurality of processor cores; a first data transfer path through which data is transferred between said processor cores and said internal memory; and a second data transfer path through which one of said processor cores performs data transfer for controlling another processor core.

In accordance with this configuration, since the channel for accessing the shared internal memory and the channel for controlling the processor cores are separated from each other, it is possible to prevent the bus bandwidth of the internal memory from being wasted due to the operations of controlling the processor cores.

In the above multiprocessor, the said processor core that controls another processor core by the use of the second data transfer path is a central processing unit capable of decoding and executing program instructions. In accordance with this configuration, it is possible to dynamically control the respective processor cores by software.

In accordance with a fourth aspect of the present invention, a multiprocessor comprises: a direct memory access processing unit operable to perform direct memory access transfer of transfer source data in response to each of direct memory access transfer requests, wherein said direct memory access processing unit includes an decompression unit for decompressing compressed data, wherein the transfer source data transferred in response to one direct memory access request is composed of one or more blocks, and compressed data and decompressed data can be mixed in blocks, and wherein, with respect to compressed data, said direct memory access processing unit transfers data to a destination while decompressing the data by the decompression unit, and with respect to non-compressed data, said direct memory access processing unit transfers data to a destination without decompression by the decompression unit.

In accordance with this configuration, since data (inclusive of program codes) to be transferred to the destination memory (for example, an internal memory) can be stored in the transfer source memory (for example, an external memory) in the form of compressed data, it is possible to reduce the memory capacity of the transfer source. In addition, since the data can be transferred in the form of the compressed data, it is possible to reduce the amount of data to be transferred and the bus bandwidth which is consumed by the function unit issuing direct memory access transfer requests. Furthermore, it is possible to reduce the time required for data transfer. In the case where a bus (for example, an external bus) is shared by the direct memory access controller and the other function units (for example, a CPU, an RPU and an SPU), it is possible to increase the length of time which can be spared for the other function units by the reduction of the consumed bus bandwidth, and shorten the latency until the other function unit gets a bus use permission after issuing a bus use request by the reduction of data transfer time.

Also, since compressed data and non-compressed data can be mixed in transferring data during one direct memory access transfer process, it is possible to reduce the number of times of issuing a direct memory access transfer request as compared with the case where separate direct memory access transfer requests have to be issued for compressed data and non-compressed data respectively. Accordingly, it is possible to reduce the processing load relating to the direct memory access transfer request of a function unit, and thereby to use the capacity of this function unit for performing other processes. Because of this, the total performance of the function unit can be enhanced. Furthermore, since a program can be written without managing compressed data and non-compressed data in distinction from each other, it is possible to lessen the burden on the programmer.

While all the data may be compressed for direct memory access transfer, there is some data which is compressed only at a low compression rate so that little advantage is expected by the compression. Even if such data is compressed, not only little advantage but also the processing load increased due to the decompression process, are expected. Accordingly, by making it possible to mix compressed data and non-compressed data, it is possible not only to improve the total performance of the function unit which issues a direct memory access transfer request, but also to improve the total performance of the direct memory access controller itself.

Furthermore, since the direct memory access controller performs direct memory access transfer while performing data decompression (in a concurrent manner), the function unit (for example, a CPU) which issues the direct memory access transfer request need not perform the decompression process so that the load on the function unit can be decreased. In addition to this, since the data transfer to the destination is performed while performing data decompression, it is possible to speed up the data transfer as compared with the case where the data transfer is performed after the completion of data decompression.

In this direct memory access controller, if a block contains a code which matches a predetermined compressed block identification code, said direct memory access processing unit transfers compressed data contained in this block to the decompression unit, wherein the decompression unit decompresses the compressed data.

In accordance with this configuration, even if compressed data and non-compressed data is mixed, it is easy to separate the compressed data and the non-compressed data only by inserting the predetermined compressed block identification code into the block.

In this direct memory access controller, said direct memory access processing unit further comprises a compressed block identification code register for storing the compressed block identification code, wherein the compressed block identification code stored in the compressed block identification code register can be externally rewritten.

In accordance with this configuration, since the compressed block identification code is stored in a register which can be rewritten by an external unit (for example, a CPU), it is possible to dynamically change the compressed block identification code during running software. Even in the case where there are a substantial number of blocks containing non-compressed data so that it is impossible to select as an compressed block identification code a data item which is not contained in any block containing non-compressed data, it is possible to mix compressed data and non-compressed data with no problem by dynamically changing the compressed block identification code.

In the direct memory access controller, the compressed data contained in the block is data which is compressed by a compression method in which data sequences registered in a dictionary is searched for a data sequence having a maximum data length which matches a data sequence to be encoded, and in which the position information and length information of the matching data sequence is output as codes, wherein the compressed data comprises first data streams and second data stream, wherein each of the second data streams contains either raw data which is not compressed or the position information of the matching data sequence, wherein the first data streams contain information used for determining raw or compressed data, and the length information of the matching data sequence, and wherein the decompression unit outputs the raw data on the basis of the determining information and restores the encoded data from the length information and the position information by determining the length information of the matching data sequence on the basis of the determining information.

In accordance with this configuration, it is possible to perform an decompression process on the basis of a slide dictionary method.

In this direct memory access controller, the data sequence to be registered in the dictionary is data which is output from the decompression unit, and is continuously updated by data which is recently output from the decompression unit.

In the direct memory access controller, the length information of the matching data sequence is variable-length encoded, and the decompression unit restores the length information which is variable-length encoded, and restores the encoded data from the position information and this length information as restored by restoring the length information which is variable-length encoded.

In accordance with this configuration, it is possible to increase the compression rate of the data stored in the transfer source.

The above direct memory access controller arbitrates the direct memory access transfer requests issued from a plurality of processor cores each of which performs arithmetic operations, and performs direct memory access transfer, wherein the decompression unit performs an decompression process only in response to the direct memory access transfer requests issued from predetermined one or more processor cores of the plurality of processor cores.

In accordance with this configuration, since an decompression process is performed only in response to the direct memory access transfer request issued from the predetermined processor core, it is possible to avoid an unnecessary increase in the processing load for decompression and thereby to prevent the process from being delayed. For example, there is a processor core which issues a request for direct memory access transfer of data for which compression is not effective, it is possible to set the data decompression process not to be performed in response to a direct memory access transfer request issued from this processor core.

This direct memory access controller further comprises: a plurality of buffers each of which is operable to store the direct memory access transfer request issued from a corresponding one of said processor cores; an arbitration unit operable to perform arbitration among a plurality of the direct memory access transfer requests which are output from a plurality of said buffers, and output one of the direct memory access transfer requests; and a queue operable to hold a plurality of the direct memory access transfer requests, and output the direct memory access transfer requests output from said arbitration unit in the order of reception, wherein the direct memory access controller performs direct memory access transfer in response to the direct memory access transfer requests output from said queue.

In accordance with a fifth aspect of the present invention, a direct memory access controller is operable to arbitrate the direct memory access transfer requests issued from a plurality of processor cores each of which performs arithmetic operations, performs direct memory access transfer between an internal memory shared by the plurality of processor cores and an external memory connected to an external bus, said direct memory access controller, and comprises: a plurality of buffers each of which is operable to store the direct memory access transfer request issued from a corresponding one of said processor cores; an arbitration unit operable to perform arbitration among a plurality of the direct memory access transfer requests which are output from a plurality of said buffers, and output one of the direct memory access transfer requests; a queue operable to hold a plurality of the direct memory access transfer requests, and output the direct memory access transfer requests output from said arbitration unit in the order of reception; and a direct memory access transfer processing unit operable to perform direct memory access transfer in response to the direct memory access transfer requests output from said queue.

In accordance with this configuration, there are a plurality of buffers and a queue for holding a plurality of direct memory access transfer requests from a plurality of processor cores. Accordingly, even during performing direct memory access transfer, another direct memory access transfer request can be accepted. Particularly, this is effective in the case where there is only one direct memory access channel.

In accordance with a sixth aspect of the present invention, a serial data transmitting and receiving device is operable to transmit and receive serial data, and comprises: a serial/parallel conversion unit operable to convert received serial data to parallel data; and a parallel/serial conversion unit operable to convert parallel data to serial data; and a transmitting and receiving buffer access unit operable to write received data to and read transmission data from a transmitting and receiving buffer defined in a shared memory which is provided outside of the serial data transmitting and receiving device and shared by the serial data transmitting and receiving device and another function unit, wherein the serial/parallel conversion unit monitors the received data, and outputs the received data, as valid received data, to the transmitting and receiving buffer access unit from the time point at which the received data is first changed after setting the start of receiving data, and wherein the parallel/serial conversion unit outputs, as valid received data, the transmission data received from the transmitting and receiving buffer access unit after setting the start of transmitting data.

In accordance with this configuration, since the buffer for serial data transmission and reception, i.e., the transmitting and receiving buffer is defined in the shared memory which is shared with other function units, and the shared memory can be directly accessed from the serial data transmitting and receiving device without the aid of the other function unit (for example, a CPU or the like) so that large size data can be easily transmitted and received, the other function unit can acquire received data and set transmission data only by accessing the shared memory and thereby it is possible to effectively handle transmission and reception data to/from the other function unit (for example, a CPU or the like). Moreover, in the case where the transmission and reception of serial data is not performed, the area of the transmitting and receiving buffer can be used by another function unit for another purpose. Furthermore, since storing the received data in the transmitting and receiving buffer is started from the time point at which the received data is first changed after setting the start of receiving data, invalid received data preceding the first valid received data is not stored in the shared memory and thereby it is possible to effectively perform the process of the received data by the other function unit (for example, a CPU or the like).

In this serial data transmitting and receiving device, when it is detected that the received data is first changed after setting the start of receiving data, the serial/parallel conversion unit outputs the received data to the transmitting and receiving buffer access unit, as valid received data, inclusive of one bit which is received just before the change.

In accordance with this configuration, since one bit received just before the time point at which the first received data is changed is stored in the transmitting and receiving buffer, it is possible to perform the process of detecting the start bit of a packet and so forth by the other function unit (for example, a CPU or the like) with a higher degree of accuracy.

In this serial data transmitting and receiving device, when a predetermined amount of data has been completely transmitted, the parallel/serial conversion unit stops the data transmission without receiving an instruction.

In accordance with this configuration, when a predetermined amount of data has been completely transmitted, the data transmission is automatically stopped, and thereby uncertain data stored in the transmitting and receiving buffer is not accidentally transmitted.

In this serial data transmitting and receiving device, a start address and an end address of the transmitting and receiving buffer are set respectively as physical addresses of the shared memory by a function unit external to the serial data transmitting and receiving device.

In accordance with this configuration, since the position and size of the area of the transmitting and receiving buffer can be freely set in the shared memory, it is possible to use the shared memory effectively from the view point of the overall system by assigning an area of a necessary and sufficient size to the transmitting and receiving buffer, and using the remaining area for the other function units.

In this serial data transmitting and receiving device, the start address and end address of the transmitting and receiving buffer can be set to arbitrary values by the function unit external to the serial data transmitting and receiving device.

In this serial data transmitting and receiving device, the transmitting and receiving buffer access unit is provided with a pointer pointing to a read position of the transmitting and receiving buffer from which the transmission data is read, or a write position of the transmitting and receiving buffer from which the received data is written, wherein the value of the pointer is incremented each time data is transmitted or received, and reset to the start address when the value of the pointer reaches the end address.

In accordance with this configuration, it is possible to use part of the shared memory, that is, the transmitting and receiving buffer in this case, as a ring buffer.

The novel features of the invention are set forth in the appended claims. The invention itself, however, as well as other features and advantages thereof, will be best understood by reading the detailed description of specific embodiments in conjunction with the accompanying drawings.

### BRIEF DESCRIPTION OF THE DRAWINGS

FIG. 1 is a block diagram showing the internal structure of a multimedia processor 1 in accordance with an embodiment of the present invention.

FIG. 2 is a view for explaining the address space of an external bus 51.

FIG. 3 is a view for showing an example of the EBI priority level table which is referred to when an external memory interface 3 performs arbitration.

FIG. 4 is a view for explaining the control registers provided of the external memory interface 3.

FIG. 5 is a block diagram for showing a DMA request queue 45 of a DMAC 4 and the peripheral circuits thereof.

FIG. 6 is a view for showing an example of the DMA priority level table which is referred to when the DMAC 4 performs arbitration.

FIG. 7 is a view for explaining the control registers provided of the DMAC 4.

FIG. 8 is a timing chart of the read cycle of the random access operation through a NOR interface.

FIG. 9 is a timing chart of the read cycle of the page mode access operation through a page mode supporting NOR interface.

FIG. 10 is a timing chart of the write cycle of the random access operation through the NOR interface.

FIG. 11 is a timing chart of the read cycle through a NAND interface.

FIG. 12 is an explanatory view for showing the data decompressing direct memory access transfer which is performed in response to one direct memory access transfer request.

FIG. 13 is a view showing the structure of the compressed block of FIG. 12.

FIG. 14 is an explanatory view for showing assignment of codes when performing Huffman coding.

FIG. 15 is a block diagram showing the details of the internal configuration of the DMAC 4.

FIG. 16 is a block diagram showing the internal configuration of the external interface block 21 of FIG. 1.

FIG. 17 is a block diagram showing the internal configuration of the general purpose parallel/serial conversion port 91 of FIG. 16.

FIG. 18 is a timing chart of the data reception process which is performed by the general purpose parallel/serial conversion port 91 of FIG. 16.

FIG. 19 is a timing chart of the data transmission process which is performed by the general purpose parallel/serial conversion port 91 of FIG. 16.

FIG. 20 is an explanatory view for showing the transmitting and receiving buffer SRB which is defined on the main RAM 25 of FIG. 1 for the general purpose parallel/serial conversion port 91.

FIG. 21 is a view for explaining the control registers provided in association with the general purpose parallel/serial conversion port 91 of FIG. 16.

### BEST MODE FOR CARRYING OUT THE INVENTION

In what follows, an embodiment of the present invention will be explained in conjunction with the accompanying drawings. Meanwhile, like references indicate the same or functionally similar elements throughout the respective drawings, and therefore redundant explanation is not repeated. Also, when it is necessary to specify a particular bit or bits of a signal in the description or the drawings, [a] or [a:b] is suffixed to the name of the signal. While [a] stands for the a-th bit of the signal, [a:b] stands for the a-th to b-th bits of the signal. While a prefixed “0b” is used to designate a binary number, a prefixed “0x” is used to designate a hexadecimal number.

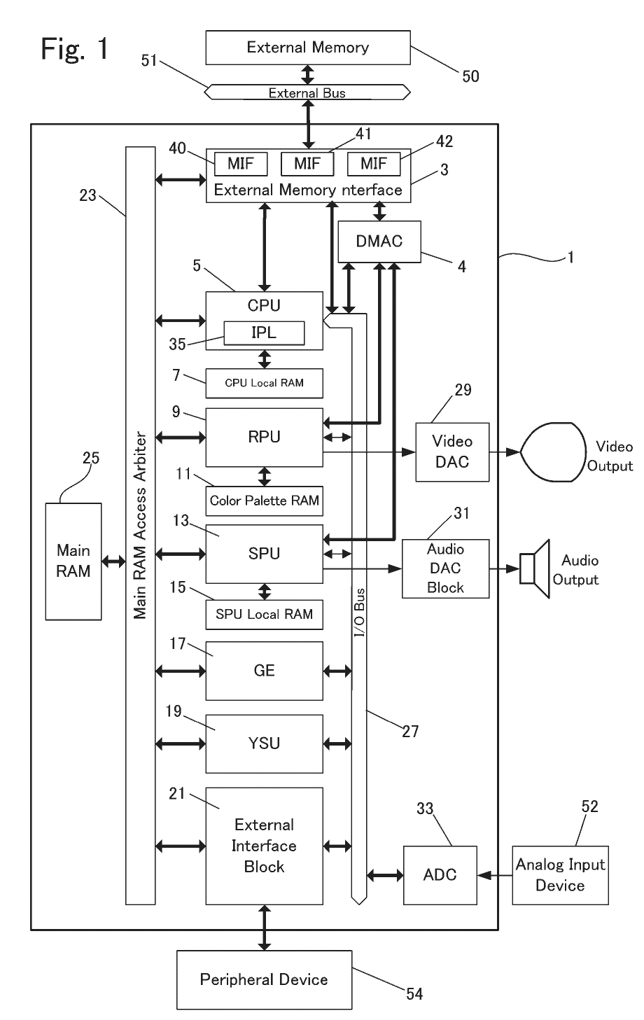

FIG. 1 is a block diagram showing the internal structure of a multimedia processor 1 as a multiprocessor in accordance with the embodiment of the present invention. As shown in FIG. 1, this multimedia processor 1 comprises an external memory interface 3, a DMAC (direct memory access controller) 4, a central processing unit (referred to as the “CPU” in the following description) 5, a CPU local RAM 7, a rendering processing unit (referred to as the “RPU” in the following description) 9, a color palette RAM 11, a sound processing unit (referred to as the “SPU” in the following description) 13, an SPU local RAM 15, a geometry engine (referred to as the “GE” in the following description) 17, a Y sorting unit (referred to as the YSU in the following description) 19, an external interface block 21, a main RAM access arbiter 23, a main RAM 25, an I/O bus 27, a video DAC (digital to analog converter) 29, an audio DAC block 31 and an A/D converter (referred to as the “ADC” in the following description) 33. The external memory interface 3 includes memory interfaces (MIF) 40, 41 and 42. The CPU 5 includes an IPL (initial program loader) 35.

In this description, the CPU 5, the RPU 9, the SPU 9, the GE 17 and the YSU 19 are referred to also respectively as a processor core. Also, the main RAM 25 and the external memory 50 are generally referred to as the “memory MEM” in the case where they need not be distinguished.

The external memory interface 3, which is one of the characteristic features of the present invention, serves to read data from the external memory 50, and write data to the external memory 50, respectively through the external bus 51. The memory interface 40 is a standard asynchronous interface (hereinafter referred to as “NOR interface”), the memory interface 41 is a standard asynchronous page mode supporting interface (hereinafter referred to as “NOR page mode supporting interface”), and the memory interface 42 is a NAND flash EEPROM compatible interface (hereinafter referred to as “NAND interface”). The external memory interface 3 will be explained in detail later.

The DMAC 4, which is one of the characteristic features of the present invention, serves to perform DMA transfer between the main RAM 25 and the external memory 50 which is connected to the external bus 51. The DMAC 4 will be explained in detail later.

The CPU 5 performs various operations and controls the overall system in accordance with a program stored in the memory MEM. Also, the CPU 5 can issue a request, to the DMAC 4, for transferring a program and data and, alternatively, can fetch program codes directly from the external memory 50 and access data stored in the external memory 50 through the external memory interface 3 and the external bus 51 but without intervention of the DMAC 4. The IPL 35 loads a program, which is initially invoked when the system is powered up or reset, from the external memory 50.

The I/O bus 27, which is one of the characteristic features of the present invention, is a bus for system control and used by the CPU 5 as a bus master for accessing the control registers of the respective function units (the external memory interface 3, the DMAC 4, the RPU 9, the SPU 13, the GE 17, the YSU 19, the external interface block 21 and the ADC 33) as bus slaves and the local RAMs 7, 11 and 15. In this way, these function units are controlled by the CPU 5 through the I/O bus 27.

The CPU local RAM 7 is a RAM dedicated to the CPU 5, and used to provide a stack area in which data is saved when a sub-routine call or an interrupt handler is invoked and provide a storage area of variables which is used only by the CPU 5.

The RPU 9 serves to generate three-dimensional images each of which is composed of polygons and sprites on a real time base. More specifically speaking, the RPU 9 reads the respective structure instances of the polygon structure array and sprite structure array, which are sorted by the YSU 19, from the main RAM 25, and generates an image for each horizontal line in synchronization with scanning the screen (display screen) by performing predetermined processes. The image as generated is converted into a data stream indicative of a composite video signal wave, and output to the video DAC 29. Also, the RPU 9 is provided with the function of issuing a DMA transfer request to the DMAC 4 for receiving the texture pattern data of polygons and sprites.

The texture pattern data is two-dimensional pixel array data to be arranged on a polygon or a sprite, and each pixel data item is part of the information for designating an entry of the color palette RAM 11. In what follows, the pixels of texture pattern data are generally referred to as “texels” in order to distinguish them from “pixels” which are used to represent picture elements of an image displayed on the screen.

The polygon structure array is a structure array of polygons each of which is a polygonal graphic element, and the sprite structure array is a structure array of sprites which are rectangular graphic elements respectively in parallel with the screen. Each element of the polygon structure array is called a “polygon structure instance”, and each element of the sprite structure array is called a “sprite structure instance”. Nevertheless, they are generally referred to simply as the “structure instance” in the case where they need not be distinguished.

The respective polygon structure instances stored in the polygon structure array are associated with polygons in a one-to-one correspondence, and each polygon structure instance consists of the drawing information of the corresponding polygon (containing the vertex coordinates in the screen, information about the texture pattern to be used in a texture mapping mode, and the color data (RGB color components) to be used in a gouraud shading mode). The respective sprite structure instances stored in the sprite structure array are associated with sprites in a one-to-one correspondence, and each sprite structure instance consists of the drawing information of the corresponding sprite (containing the coordinates in the screen, and information about the texture pattern to be used).

The video DAC 29 is a digital/analog conversion unit which is used to generate an analog video signal. The video DAC 29 converts a data stream which is input from the RPU 9 into an analog composite video signal, and outputs it to a television monitor and the like (not shown in the figure) through a video signal output terminal (not shown in the figure).

The color palette RAM 11 is used to provide a color palette of 512 colors, i.e., 512 entries in the case of the present embodiment. The RPU 9 converts the texture pattern data into color data (RGB color components) by referring to the color palette RAM 11 on the basis of a texel data item included in the texture pattern data as part of an index which points to an entry of the color palette.

The SPU 13 generates PCM (pulse code modulation) wave data (referred to simply as the “wave data” in the following description), amplitude data, and main volume data. More specifically speaking, the SPU 13 generates wave data for 64 channels at a maximum, and time division multiplexes the wave data, and in addition to this, generates envelope data for 64 channels at a maximum, multiplies the envelope data by channel volume data, and time division multiplexes the amplitude data. Then, the SPU 13 outputs the main volume data, the wave data which is time division multiplexed, and the amplitude data which is time division multiplexed to the audio DAC block 31. In addition, the SPU 13 is provided with the function of issuing a DMA transfer request to the DMAC 4 for receiving the wave data and the envelope data.

The audio DAC block 31 converts the wave data, amplitude data, and main volume data as input from the SPU 13 into analog signals respectively, and analog multiplies the analog signals together to generate analog audio signals. These analog audio signals are output to audio input terminals (not shown in the figure) of a television monitor (not shown in the figure) and the like through audio signal output terminals (not shown in the figure).

The SPU local RAM 15 stores parameters (for example, the storage addresses and pitch information of the wave data and envelope data) which are used when the SPU 13 performs wave playback and envelope generation.

The GE 17 performs geometry operations for displaying three-dimensional images. Specifically, the GE 17 executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The YSU 19 serves to sort the respective structure instances of the polygon structure array and the respective structure instances of the sprite structure array, which are stored in the main RAM 25, in accordance with the sort rules 1 to 4. In this case, the polygon structure array and the sprite structure array are separately sorted.

The sort rule 1 is a rule in which the respective polygon structure instances are sorted in ascending order of the minimum Y-coordinates. The minimum Y-coordinate is the smallest one of the Y-coordinates of the three vertices of the polygon. The Y-coordinate is the vertical coordinate of the screen and has a positive axis in the downward direction. The sort rule 2 is a rule in which when there are polygons having the same minimum Y-coordinate, the respective polygon structure instances are sorted in descending order of the depth values.

However, with regard to a plurality of polygons which include pixels at the top line of the screen but have different minimum Y-coordinates from each other, the YSU 19 sorts the respective polygon structure instances in accordance with the sort rule 2, rather than the sort rule 1, on the assumption that they have the same Y-coordinate. In other words, in the case where there is a plurality of polygons which includes pixels at the top line of the screen, these polygon structure instance are sorted in descending order of the depth values on the assumption that they have the same Y-coordinate. This is the sort rule 3.

The above sort rules 1 to 3 are applied also to the case where interlaced scanning is performed. However, the sort operation for displaying an odd field is performed in accordance with the sort rule 2 on the assumption that the minimum Y-coordinate of the polygon which is displayed on an odd line and/or the minimum Y-coordinate of the polygon which is displayed on the even line followed by the odd line are equal. However, the above is not applicable to the top odd line. This is because there is no even line followed by the top odd line. On the other hand, the sort operation for displaying an even field is performed in accordance with the sort rule 2 on the assumption that the minimum Y-coordinate of the polygon which is displayed on an even line and/or the minimum Y-coordinate of the polygon which is displayed on the odd line followed by the even line are equal. This is the sort rule 4.

The sort rules 1 to 4 applicable to sprites are same as the sort rules 1 to 4 applicable to polygons respectively.

The external interface block 21, which is one of the characteristic features of the present invention, is an interface with peripheral devices 54 and includes programmable digital input/output ports providing 24 channels. In what follows, these input/output ports are generally called as “PIO”. Incidentally, when the respective PIOs have to be distinguished, they are referred to as PIO 0 to PIO 23 respectively. The respective 24 channels of the PIOs are used to connect with one or a plurality of a mouse interface function of 4 channels, a light gun interface function of 4 channels, a general purpose timer/counter function of 2 channels, an asynchronous serial interface function of one channel, and a general purpose parallel/serial conversion port function of one channel. This will be described below in detail.

The ADC 33 is connected to analog input ports of 4 channels and serves to convert analog signals, which are input from an analog input device 52 through the analog input ports, into digital signals. For example, an analog signal such as a microphone voice signal is sampled and converted into digital data.

The main RAM access arbiter 23, which is one of the characteristic features of the present invention, arbitrates access requests issued from the function units (the CPU 5, the RPU 9, the GE 17, the YSU 19, the DMAC 4 and the external interface block 21 (the general purpose parallel/serial conversion port)) for accessing the main RAM 25, and grants access permission to one of the function units.

The main RAM 25 is used by the CPU 5 as a work area, a variable storing area, a virtual memory management area and so forth. Furthermore, the main RAM 25 is also used as a storage area for storing data to be transferred to another function unit by the CPU 5, a storage area for storing data which is DMA transferred from the external memory 50 by the RPU 9 and SPU 13, and a storage area for storing input data and output data of the GE 17 and YSU 19. In addition to this, it is also used as a storage area for storing the transmission and reception data of a general purpose parallel/serial conversion port 91 (to be described below) in the external interface block.

The external bus 51 is a bus for accessing the external memory 50. It is accessed through the external memory interface 3 from the IPL 35, the CPU 5 and the DMAC 4. The address bus of the external bus 51 consists of 30 bits, and is connectable with the external memory 50, whose capacity can be up to a maximum of 1 Giga bytes (=8 Giga bits). The data bus of the bus 51 consists of 16 bits, and is connectable with the external memory 50, whose data bus width is 8 bits or 16 bits. External memories having different data bus widths can be connected at the same time, and there is provided the capability of automatically switching the data bus width in accordance with the external memory to be accessed.

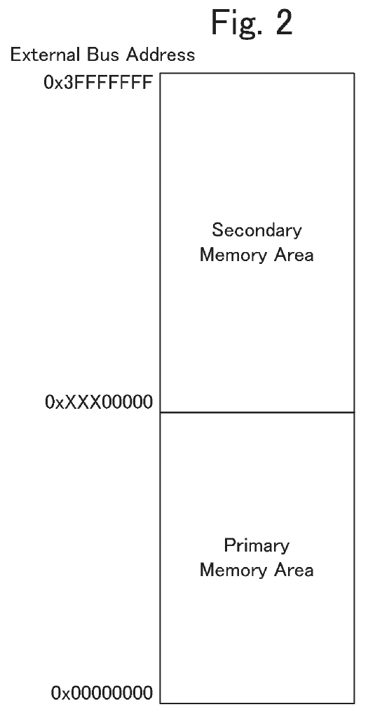

FIG. 2 is a view for explaining the address space of the external bus 51. As shown in FIG. 2, the address space of the external bus 51 is divided into two areas in order to connect with two types of external memories by way of the two areas which are referred to as a primary memory area and a secondary memory area respectively. Each of these areas is assigned to one of the memory interfaces 40 to 42. Needless to say, the two areas can be assigned to the same memory interface, or can be assigned to different memory interfaces. In what follows, the external memory interface 3 will be explained in detail.

Returning to FIG. 1, the memory interface 40, i.e., the NOR interface is a memory interface which is provided for connecting between the external memory interface 3 and the external memory 50 through the respective bits of the address and data in parallel, and provided with no clock signal for synchronization between signals. Standard mask ROMs, standard SRAMs, NOR flash EEPROMs and the like are provided with NOR interfaces. Accordingly, these memories can be used as the external memory 50.

The memory interface 41, i.e., NOR page mode supporting interface is a NOR interface which supports a page mode. Accordingly, a memory provided with a NOR interface and supporting a page mode can be used as the external memory 50. Generally speaking, a page mode is an access mode in which, when there are successive access cycles within a page defined in the memory, the access time can be shortened in the second cycle, and the subsequent access cycles within the page. The size of a page differs among the types of memories.

The memory interface 42, i.e., the NAND interface is an interface which is compatible with the interface of a NAND flash EEPROM. However, since the NAND interface of the multimedia processor 1 is not provided with the hardware required for error correction, a NAND flash EEPROM cannot be connected thereto as it is, but a NAND flash EEPROM compatible mask ROM or the like can be connected with the NAND interface. Accordingly, these memories can be used as the external memory 50.

The external memory interface 3 arbitrates external bus access request purposes (the causes of requests for accessing the external bus 51) issued from the IPL 35, the CPU 5 and the DMAC 4 in accordance with an EBI priority level table to be described below in order to select one of the external bus access request purposes. Then, accessing the external bus 51 is permitted for the external bus access request purpose as selected. These operations will be explained in detail.

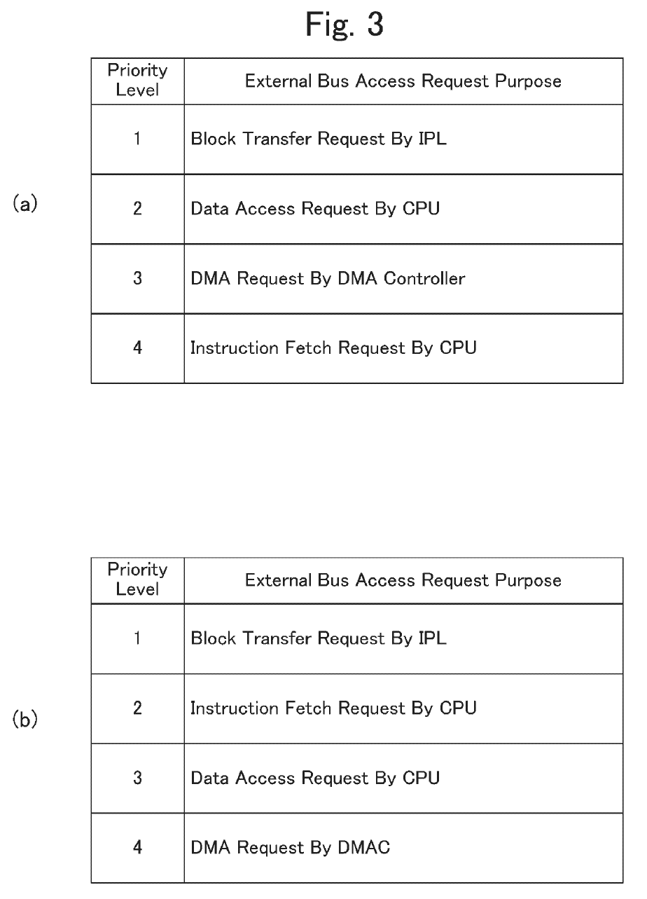

FIG. 3 is a view for showing an example of the EBI priority level table which is referred to when the external memory interface 3 performs arbitration. As illustrated in FIG. 3(a), the external bus access request purposes include the block transfer request issued from the IPL 35, the request for accessing data issued from the CPU 5, the request for DMA issued from the DMAC 4, and the request for fetching a instruction issued from the CPU 5. The priority level “1” indicates the highest priority, while the priority is lowered as the number increases.

The external memory interface 3 arbitrates the external bus access request purposes in accordance with the EBI priority level table as shown in FIG. 3(a). However, in the case where an arbitration priority ranking control register to be described below is set to “priority ranking change enabled”, the EBI priority level table shown in FIG. 3(b) is used after the request for fetching the instruction by the CPU 5 is waited for 10 microseconds or longer. In this state, after the instruction fetch is performed by the CPU 5, the EBI priority level table shown in FIG. 3(a) is used again.

Returning to FIG. 2, with respect to the external bus access request purposes, the DMA request from the DMAC 4 and the data access request from the CPU 5 can be issued to access any address throughout the address space of the external bus 51. Contrary to this, the instruction fetch request issued from the CPU 5 and the block transfer request issued from the IPL 35 can be used to access only a limited area.

In the case of the instruction fetch request issued from the CPU 5, the accessible external bus addresses are limited between 0x00000000 to 0x00FFFFFF. When the multimedia processor 1 starts, the IPL 35 transfers data (a start-up program) stored in the external bus addresses 0x00000000 to 0x000000FF to the addresses 0x0000 to 0x00FF of the main RAM 25, and the CPU 5 starts program execution from the address 0x0000 of the main RAM 25. Accordingly, in the case of the block transfer request issued from the IPL 35, no access operation is performed to the external bus addresses outside the area of 0x00000000 to 0x000000FF.

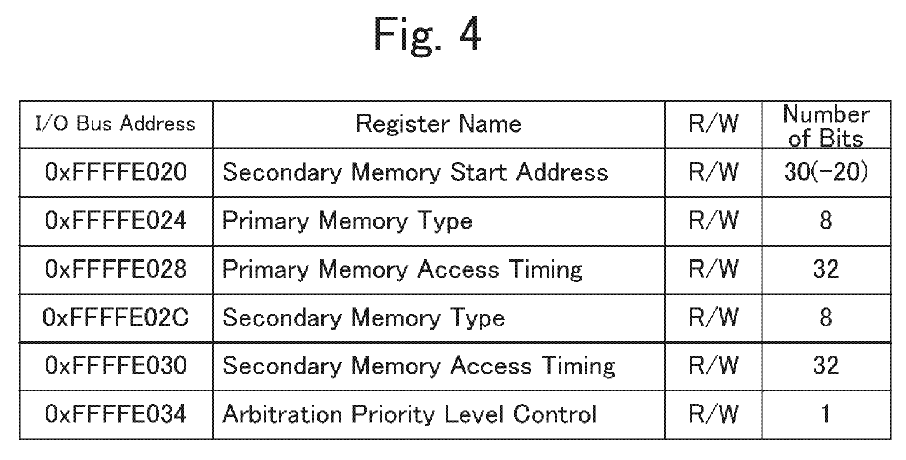

FIG. 4 is a view for explaining the control registers provided of the external memory interface 3. As shown in FIG. 4, the respective control registers are located in I/O bus addresses corresponding thereto as described in the figure and can be accessed for reading or writing operations by the CPU 5 through the I/O bus 27.

The secondary memory start address register is a control register for setting the start address of the secondary memory area, i.e., the boundary address between the primary memory area and the secondary memory area. However, only the upper 10 bits of the external bus address can be set while the lower 20 bits are fixed to “0”. Accordingly, the start address of the secondary memory area can be set in units of Megabytes (=8 M bits), as 0x00000000, 0x00100000, 0x00200000, and so forth.

The primary memory type register is a control register for setting the type of memory interface (the memory interface 40, 41 or 42) to be used for the primary memory area (the external memory), the page size (4, 8, 16, 32, 64, 128, 256 or 512 bytes), the data bus width (8 or 16 bits), and the address size (3 or 4 bytes) of the NAND interface.

The primary memory access timing register is a control register for setting the timing for accessing the primary memory area.

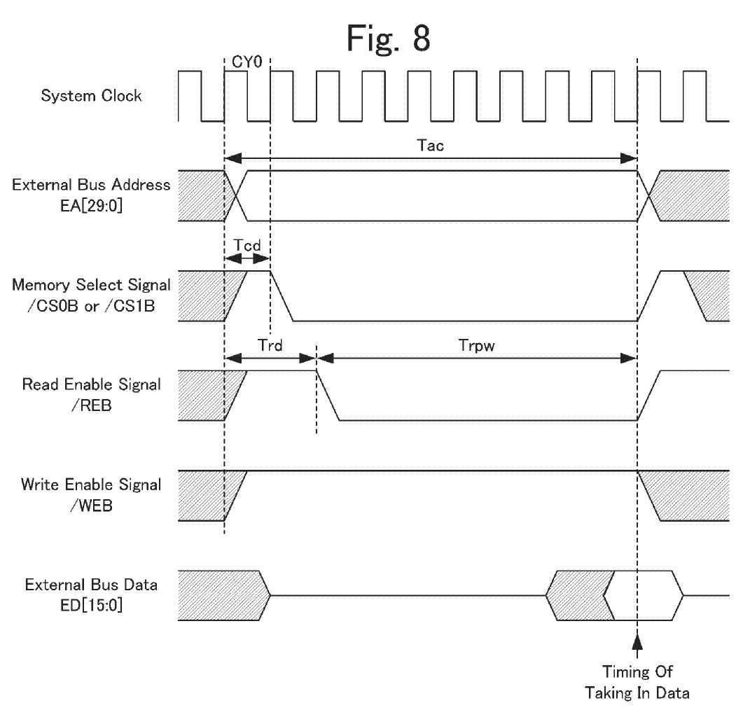

More specifically speaking, this control register is used to set the access cycle time “Tac”, the page access cycle time “Tapc” (to be used when the memory interface 41 is selected), the hold time “Tcah” (to be used when the memory interface 42 is selected) of the command latch enable signal CLE and the address latch enable signal ALE respective to the write enable signal /WE, the delay time “Tcd” of the memory select signal /CS0B from the start of the access cycle, the delay time “Trd” of the read enable signal /REB from the start of the access cycle, the pulse width Trpw of the read enable signal /REB, the delay time “Twd” of the write enable signal /WEB from the start of the access cycle, the pulse width Twpw of the write enable signal /WEB, the hold time “Tdh” of write data (to be used when the memory interface 40 or 41 other than the memory interface 42 is selected) after the rising edge of the write enable signal /WEB, the hold time “Tfdh” of write data (to be used when the memory interface 42 is selected) after the rising edge of the write enable signal /WEB, and the set-up time “Tds” of write data before the falling edge of the write enable signal /WEB. This will be apparent from the explanation with reference to FIG. 8 to FIG. 11 to be described below.

The secondary memory type register is a control register for setting the type of memory interface (the memory interface 40, 41 or 42) to be used for the secondary memory area (the external memory), the page size (4, 8, 16, 32, 64, 128, 256 or 512 bytes), the data bus width (8 or 16 bits), and the address size (3 or 4 bytes) of the NAND interface.

The secondary memory access timing register is a control register for setting the timing for accessing the secondary memory area. The specific set contents are the same as in the primary memory access timing register. However, the delay time “Tcd” is the delay time of the memory select signal /CS1B from the start of the access cycle.

The arbitration priority ranking control register is a control register for controlling the order of priority in the arbitration among the external bus access request purposes. In the case where this register is set to “1” indicative of “priority ranking change enabled”, when the CPU 5 waits for 10 microseconds or longer before the request for fetching the instruction is accepted, the EBI priority level table shown in FIG. 3(b) is used so that the priority level of the instruction fetch request issued from the CPU 5 is raised. In this state, after the instruction fetch is performed by the CPU 5, the EBI priority level table shown in FIG. 3(a) is used again. Incidentally, when this register is set to “0”, the state is changed to “priority ranking change disabled” so that the order of priority as described above is not changed.

As a result of the arbitration, the external memory interface 3 selects the memory interface 40, 41 or 42 to which is assigned the area (the primary memory area or the secondary memory area) including the external bus address output from the function unit (the IPL 35, the CPU 5 or the DMAC 4) that is allowed to access the external bus 51, and accesses the external memory 50 through the memory interface as selected.

In this case, the memory interface as selected performs the control of read/write operations on the basis of the read/write information, the information on the number of data transfer bytes and/or write data output from the function unit that is allowed to access the external bus 51.

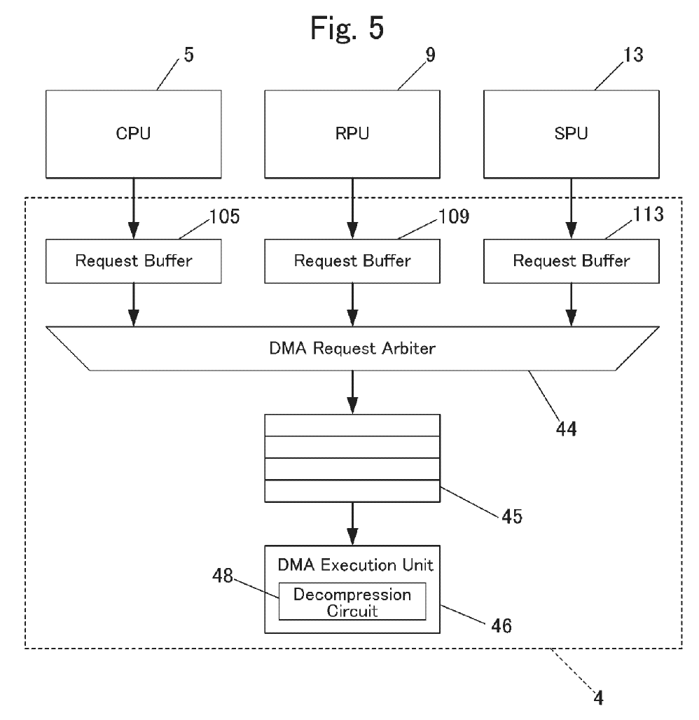

FIG. 5 is a block diagram for showing a DMA request queue 45 of the DMAC 4 and the peripheral circuits thereof. As shown in FIG. 5, the DMAC 4 includes a request buffer 105 for saving a DMA transfer request from the CPU 5, a request buffer 109 for saving a DMA transfer request from the RPU 9, a request buffer 113 for saving a DMA transfer request from the SPU 13, a DMA request arbiter 44, the DMA request queue 45 and a DMA execution unit 46. The DMA execution unit 46 includes a decompression circuit 48.

If two or more request buffers of the request buffers 105, 109 and 113 save entries as DMA transfer requests, the DMA request arbiter 44 selects one of the DMA transfer requests in accordance with a DMA priority level table to be described below, and outputs the DMA transfer request as selected to the DMA request queue 45 as the last entry. The DMA request queue 45 which accommodates four entries is made of an FIFO structure in order that DMA transfer requests are output to the DMA execution unit 46 successively from the DMA transfer request which is first accepted. The DMA execution unit 46 issues a request (the DMA request as the external bus access request purpose) for accessing the external bus 51, and when access to the external bus 51 is permitted the DMA transfer is executed in accordance with the DMA transfer request as received from the DMA request queue 45.

Since only one DMA channel is provided in the DMAC 4, it is impossible to perform multiple DMA transfer in parallel. However, since there are the DMA request queue 45 of four entries and the request buffers 105, 109 and 113 for holding the DMA transfer requests from the CPU 5, the RPU 9 and the SPU 13, it is possible to accept DMA transfer requests even during DMA transfer.

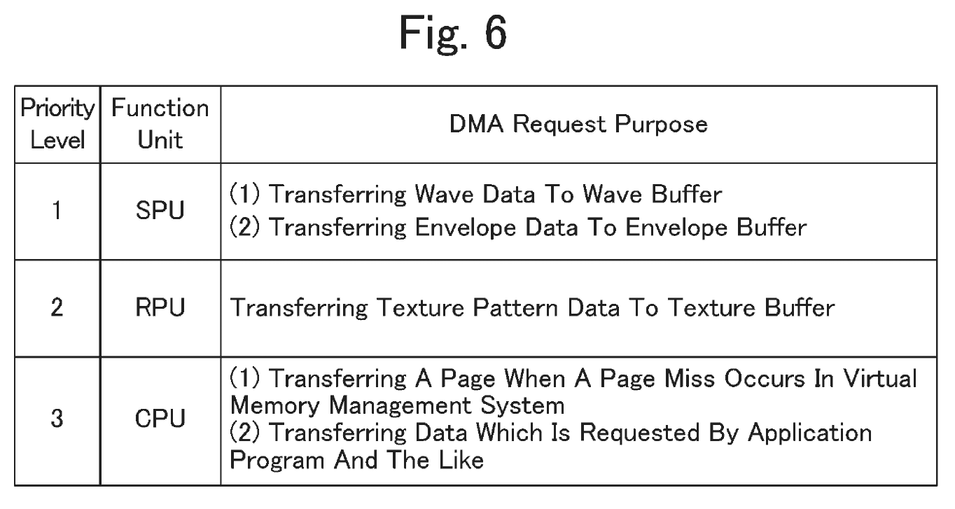

FIG. 6 is a view for showing an example of the DMA priority level table which is referred to when the DMAC 4 performs arbitration. As illustrated in FIG. 6, in the state where two or more request buffers of the request buffers 105, 109 and 113 save entries as DMA transfer requests, this DMA priority level table indicates which of the DMA transfer requests is to be preferentially output by the DMA request arbiter 44 to the DMA request queue 45.

The priority level “1” indicates the highest priority, while the priority is lowered as the number increases. That is to say, the priority levels are given, in the order from the highest priority level, the DMA transfer request by the SPU 13, the DMA transfer request by the RPU 9 and the DMA transfer request by the CPU 5. In the case of the present embodiment, the priority levels are fixed in hardware and cannot be changed.

The DMA request purposes (the causes of requests for DMA transfer) by the SPU 13, the RPU 9 and the CPU 5 will be explained in order.

As illustrated in FIG. 6, the DMA transfer request purposes issued from the SPU 13 includes (1) transferring wave data to a wave buffer and (2) transferring envelope data to an envelope buffer. The wave buffer and the envelope buffer are respectively provided as storage areas which are defined in the main RAM 25 for temporarily storing wave data and envelope data. The start address of these temporary storage areas are determined by control registers (not shown in the figure) in the SPU 13, and the size of each temporary storage area is determined by the setting of the number of playback channels. Meanwhile, the arbitration between the two DMA transfer request purposes issued from the SPU 13 is performed by hardware (not shown in the figure) within the SPU 13, but not performed by the DMAC 4.

The DMA transfer request purpose of the RPU 9 includes transferring the texture pattern data to a texture buffer. The texture buffer is provided as a storage area which is defined in the main RAM 25 for temporarily storing the texture pattern data. The start address and size of this temporary storage area are determined by control registers (not shown in the figure) in the RPU 9.

The DMA transfer request purposes issued from the CPU 5 includes (1) transferring a page when a page miss occurs in a virtual memory management system, and (2) transferring data which is requested by an application program and the like. Meanwhile, in the case where a plurality of DMA transfer requests is issued in the CPU 5 at the same time, the arbitration thereamong is performed by software which is run in the CPU 5 but not performed by the DMAC 4.

The DMA request purposes of the CPU 5 as described in the above (1) will be explained in more detail. The DMA transfer request of CPU 5 is issued by running software. In the ordinary software design of the multimedia processor 1, an OS (operating system) is responsible for virtual memory management. When a page miss occurs in the virtual memory management to give rise to a need for page swapping, the OS issues a DMA transfer request to the DMAC 4.

The DMA request purposes of the CPU 5 as described in the above (2) will be explained in more detail. When the necessity arises of transferring a certain amount of data between the external memory 50 and the main RAM 25 during running system software such as an OS or application software, a DMA transfer request is issued.

Returning to FIG. 5, the decompression circuit 48 performs data decompression on the basis of the LZ77 (Lempel-Ziv 77) algorithm. Accordingly, in response to a DMA transfer request of the CPU 5, while decompressing the compressed data stored in the external memory 50, the DMAC 4 can DMA transfer the data to the main RAM 25. As described above, in the case of the present embodiment, it is possible to decompress and DMA transfer the compressed data as long as the DMA transfer request is issued by the CPU 5. The data decompressing DMA transfer will be described below in detail.

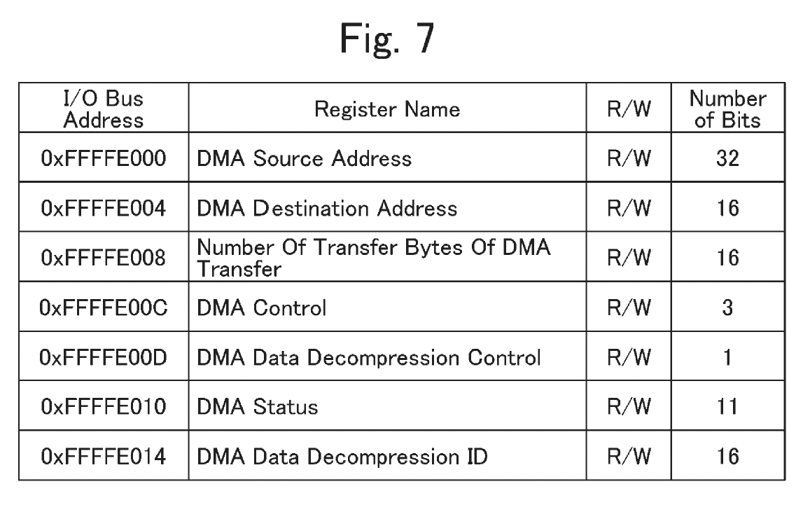

FIG. 7 is a view for explaining the control registers provided of the DMAC 4. As shown in FIG. 7, the respective control registers are located in I/O bus addresses corresponding thereto as described in the figure and can be accessed for reading or writing operations by the CPU 5 through the I/O bus 27. Namely, these control registers are set up when a DMA transfer request is issued by the CPU 5.

The transfer source address of DMA transfer is set in the DMA transfer source address register as a physical address of the external bus 51. The DMA destination address of DMA transfer is set in the DMA destination address register as a physical address of the main RAM 25. The number of transfer bytes of DMA transfer is set in the DMA transfer byte count register. In the data decompressing DMA, the number of bytes is counted after decompression.

The DMA control register is a register for performing various control operations of the DMAC 4, and includes a DMA transfer enable bit, a DMA start bit and an interrupt enable bit. The DMA transfer enable bit is a bit for controlling DMA transfer requested by the CPU 5 to be enabled/disabled. When the DMA start bit is set to “1”, the DMA transfer request (the transfer source address, the transfer destination address and the transfer byte count) written to the request buffer 105 corresponding to the CPU 5 is output to the DMA request queue 45. The interrupt enable bit is a bit for controlling whether or not an interrupt request is issued to the CPU 5 when the DMA transfer as requested by the CPU 5 is completed.

The DMA data decompression control register includes a data decompression enable bit. This bit is a bit for controlling data decompression to be enabled/disabled during DMA transfer as requested by the CPU 5. The DMA status register is a register indicative of various statuses of the DMAC 4, and includes a request queue busy bit, a DMA completion bit, a DMA in-progress bit, and a DMA unfinished count field.

The request queue busy bit indicates the status (busy /ready) of the DMA request queue 45. When the state of the DMA request queue 45 is “busy”, no DMA transfer request enters anew the DMA request queue 45. The DMA completion bit is set to “1” each time DMA transfer requested by the CPU 5 is completed. When the interrupt enable bit is set enabled, an interrupt request is issued to the CPU 5 at the same time as the DMA completion bit is set to “1”. The DMA in-progress bit is a bit indicating whether or not the DMA transfer is in progress. The DMA unfinished count field is a field indicative of the number of the DMA transfer requests which are issued from the CPU 5 and have not been finished yet.

The DMA data decompression ID register is used to store an ID code of the data decompressing DMA. In the case where the DMA data decompression control register is set enabled, when the initial two bytes of a block of 256 bytes agrees with the ID code which is set in the DMA data decompression ID register, the DMAC 4 recognizes the block as a compressed block and performs data decompression.

Next, the access operation to the external memory 50 will be explained with reference to the timing charts of FIG. 8 to FIG. 11. Meanwhile, in the explanation with reference to FIG. 8 to FIG. 11, the period 1T is one cycle of the system clock of the multimedia processor 1, and corresponds to about 10.2 nanoseconds.

FIG. 8 is a timing chart of the read cycle of the random access operation through the NOR interface. In the example of FIG. 8, Tac=9T, Tcd=1T, Trd=2T and Trpw=7T. The periods “Tac”, “Tcd”, “Trd” and “Trpw” have meanings as explained in conjunction with FIG. 4. In this case, it is assumed that the data bus width of the external bus 51 is set to 16 bits.

These periods have to satisfy the following requirements.

Tac≧Trd+Trpw.

Tac≧2T.

Tac>Tcd.

Trpw>0T.

In the case where these requirements are not satisfied, the data written to the primary memory access timing register and the secondary memory access timing register of the external memory interface 3 is ignored.

Referring to FIG. 8, the memory interface 40 starts outputting the external bus address EA[29:0] in the starting cycle CY0 of the access cycle period “Tac” to the external bus 51. The external bus address EA is output in the access cycle period “Tac”. Then, the memory interface 40 asserts the memory select signal /CSB0 or /CSB1 the period “Tcd” after the system clock rises up in the starting cycle CY0. Furthermore, the memory interface 40 asserts the read enable signal /REB the period “Trd” after the system clock rises up in the starting cycle CY0. Then, the memory interface 40 takes in data ED[15:0], which is read from the external memory 50 to the external bus 51, at the rising edge of the system clock in the final cycle of the access cycle “Tac”. Incidentally, since it is a read access, the write enable signal /WEB is maintained negated.

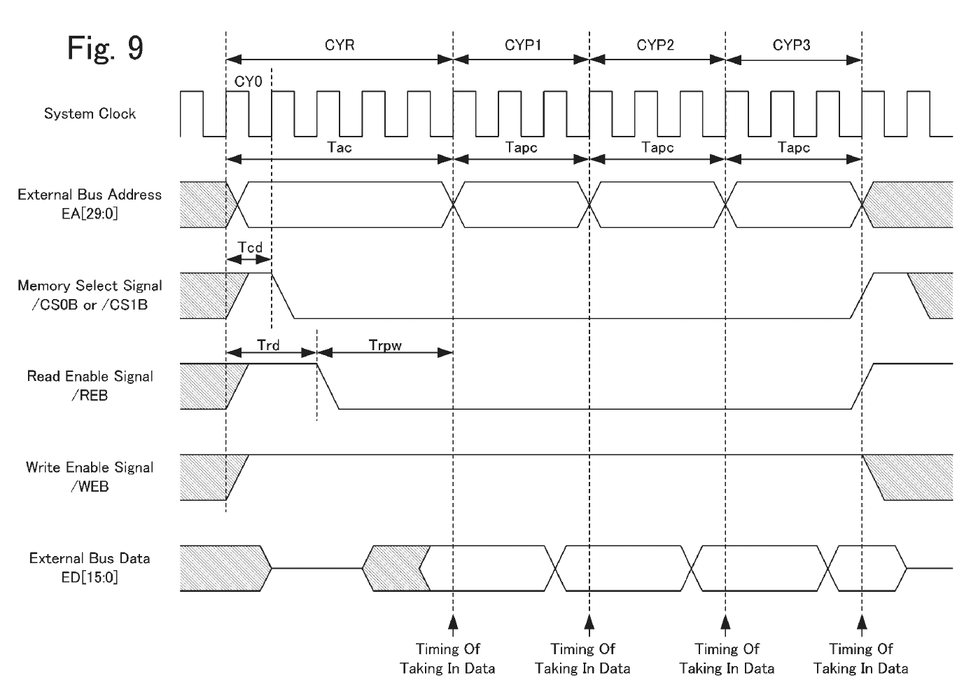

FIG. 9 is a timing chart of the read cycle of the page mode access operation through the page mode supporting NOR interface. In the example of FIG. 9, Tac=5T, Tapc=3T, Tcd=1T, Trd=2T and Trpw=3T. The periods “Tac”, “Tapc”, “Tcd”, “Trd” and “Trpw” have meanings as explained in conjunction with FIG. 4. However, in FIG. 9, the period “Tac” is the cycle time of random access. In this case, it is assumed that the data bus width of the external bus 51 is set to 16 bits.

These periods have to satisfy the following requirements.

Tac≧Trd+Trpw.

Tac≧2T.

Tapc>0T.

Tac>Tcd.

Trpw>0T.

In the case where these requirements are not satisfied, the data written to the primary memory access timing register and the secondary memory access timing register of the external memory interface 3 is ignored.

Referring to FIG. 9, the first read cycle CYR of which the length is defined by the period “Tac” is the cycle of the random access, and the subsequent three read cycles CYP1 to CYP3 of which the lengths are defined by the period “Tapc” are the cycle of the page mode access.

The memory interface 41 starts outputting the external bus address EA[29:0] to the external bus 51 in the starting cycle CY0 of the access cycle period “Tac”. The external bus address EA is output in the access cycle period “Tac”. Then, the memory interface 41 asserts the memory select signal /CSB0 or /CSB1 the period “Tcd” after the system clock rises up in the starting cycle CY0. Furthermore, the memory interface 41 asserts the read enable signal /REB the period “Trd” after the system clock rises up in the starting cycle CY0. Then, the memory interface 41 takes in data ED[15:0], which is read from the external memory 50 to the external bus 51, at the rising edge of the system clock in the final cycle of the first read cycle CYR.

In the next read cycle CYP1, the memory interface 41 outputs the next external bus address EA to the external memory 50. Then, the memory interface 41 takes in data ED anew, which is read from the external memory 50 to the external bus 51, at the rising edge of the system clock in the final cycle of the read cycle CYP1. This operation is performed also in the subsequent read cycles CYP2 and CYP3.

As has been discussed above, in the case of the page mode access, the memory select signals /CSB0 and /CSB1 and the read enable signal /REB have to be controlled only in the first read cycle CYR but need not be controlled in the subsequent read cycles CYP1 to CYP3, so that high speed accessing can be performed. Incidentally, since it is a read access, the write enable signal /WEB is maintained negated.

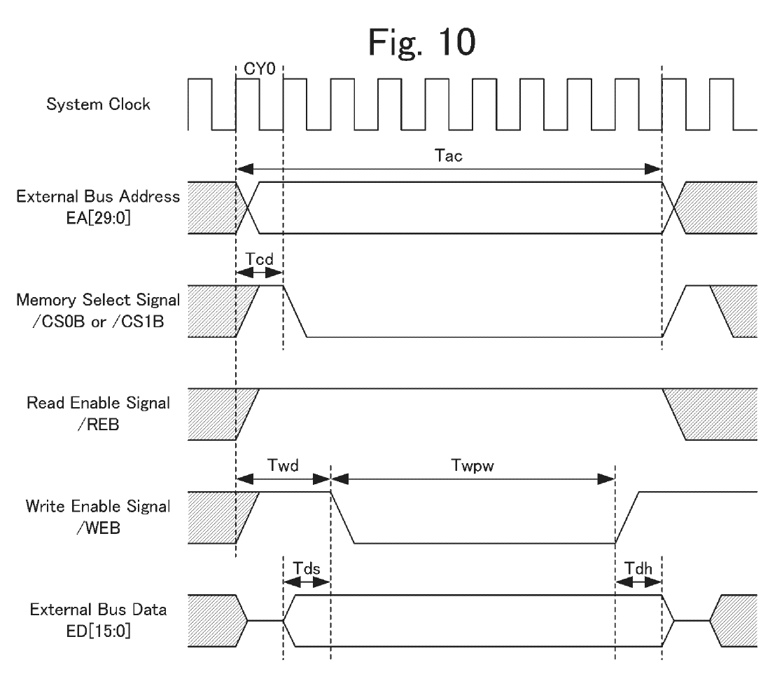

FIG. 10 is a timing chart of the write cycle of the random access operation through the NOR interface. In the example of FIG. 10, Tac=9T, Tcd=1T, Twd=2T, Twpw=6T, Tds=1T and Tdh=1T. The periods “Tac”, “Tcd”, “Twd”, “Twpw”, “Tds” and “Tdh” have meanings as explained in conjunction with FIG. 4. In this case, it is assumed that the data bus width of the external bus 51 is set to 16 bits.

These periods have to satisfy the following requirements.

Tac≧Twd+Twpw.

Tac≧2T.

Tac>Tcd.

Twpw>0T.

Twd≧Tds.

In the case where these requirements are not satisfied, the data written to the primary memory access timing register and the secondary memory access timing register of the external memory interface 3 is ignored.

Referring to FIG. 10, the memory interface 40 starts outputting the external bus address EA[29:0] to the external memory 50 in the starting cycle CY0 of the access cycle period “Tac”. The external bus address EA is output in the access cycle period “Tac”. Then, the memory interface 40 asserts the memory select signal /CSB0 or /SCB1 the period “Tcd” after the system clock rises up in the starting cycle CY0. Furthermore, the memory interface 40 asserts the write enable signal /WEB the period “Twd” after the system clock rises up in the starting cycle CY0.

The memory interface 40 starts outputting the write data ED[15:0] to the external bus 51 in advance of asserting the write enable signal /WEB, i.e., the time “Tds” before the write enable signal /WEB is asserted. Also, the memory interface 40 continues outputting the write data ED to the external bus 51 for the time “Tdh” after the write enable signal /WEB is negated. Incidentally, since it is a write access, the read enable signal /REB is maintained negated.

Meanwhile, even when the area to be accessed (refer to FIG. 2) is set to the page mode, the page mode access is not performed for the write cycle, in which random access is always performed.

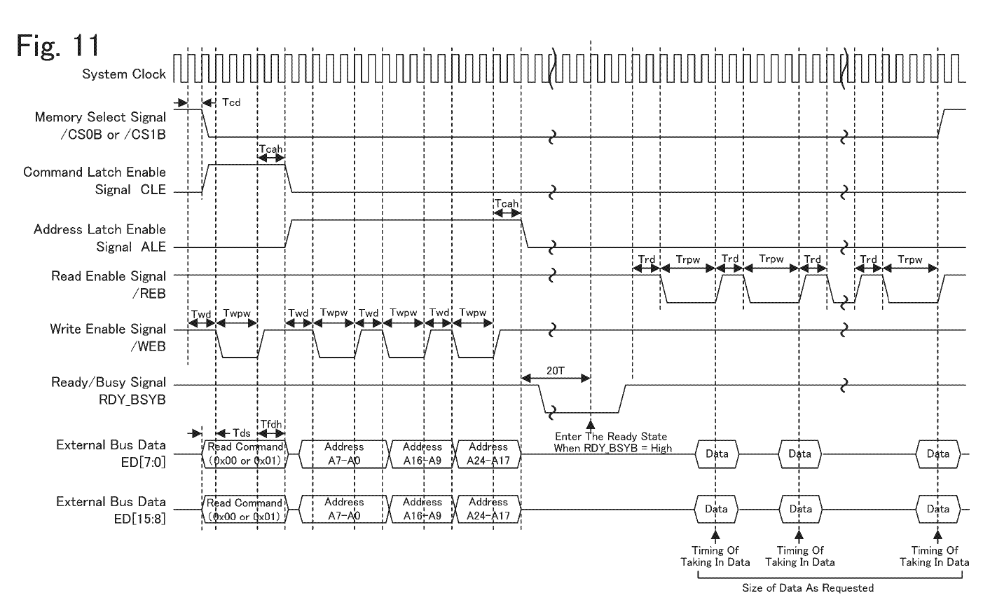

FIG. 11 is a timing chart of the read cycle through the NAND interface. In the example of FIG. 11, Tcd=1T, Tcah=2T, Twd=2T, Twpw=3T, Tds=1T, Tfdh=2T, Trd=2T and Trpw=4T. The settings of these periods are as explained with reference to FIG. 4. In this case, it is assumed that the data bus width of the external bus 51 is set to 16 bits.

Referring to FIG. 11, when accessing the external memory 50 having a NAND interface, the memory interface 42 first issues a read command to the external memory 50. In this case, the memory interface 42 asserts a command latch enable signal CLE. There are two types of read commands, “0x00” and “0x01”, as commands issued by the memory interface 42. The two types of read commands are provided because the LSB of each command indicates the eighth bit A8 of the read start address.

Next, the memory interface 42 issues the read start address to the external memory 50. In this case, the memory interface 42 asserts the address latch enable signal ALE. The read start address is issued in three divided 8-bit partial addresses. However, in the case where of the capacity of the external memory 50 which is connected is larger than 32 Megabytes, the setting of the mode is changed in order to input the read start address in four divided 8-bit partial addresses. This setting is made through the primary memory type register or the secondary memory type register of the external memory interface 3.

When these commands and the read start address are issued, the write enable signal /WEB is asserted.

In this case, the period “Twd” indicates the delay time of asserting the write enable signal /WEB from the first cycle of issuing the command or the read start address. Also, the period “Twpw” indicates the length of the period in which the write enable signal /WEB is asserted. The period “Tcah” is the hold time of the command latch enable signal CLE and the address latch enable signal ALE respective to the write enable signal /WE; the period “Tcd” is the delay time of the memory select signal /CS0B or /CS1B from the start of the access cycle, the period “Tfdh” is the hold time of the read command after the rising edge of the write enable signal /WEB; and the period “Tds” is the set-up time of the read command before the falling edge of the write enable signal /WEB.

The external memory 50 enters a busy state after the read start address is input. In the busy state, the external memory 50 sets a ready/busy signal RDY_BSYB to a low level (busy). When detecting the transition of the ready/busy signal RDY_BSYB from a low level (busy) to a high level (ready), the memory interface 42 starts reading data.

However, when the busy state is shorter than one cycle of the system clock, the busy state may not be detected by the memory interface 42. Thereby, since the delay time of outputting the ready/busy signal of the external memory 50 is up to a maximum of 200 nanoseconds, if the ready/busy signal RDY_BSYB is already at a high level (ready) 200 nanoseconds after the last byte of the read start address is issued, it is determined that the external memory 50 has entered the ready state after the busy state. Accordingly, if the ready/busy signal RDY_BSYB indicates a high level (ready) 20T after the last byte of the read start address is issued, the memory interface 42 immediately starts reading data.

When starting reading data, the memory interface 42 asserts the read enable signal /REB and reads data from the external memory 50. The external memory 50 connected to the NAND interface outputs word data from consecutive memory addresses to the data bus ED of the external bus 51 each time the read enable signal /REB is asserted. The memory interface 42 takes in read data from the data bus ED of the external bus 51 at the end of one read cycle, i.e., at the rising edge of the system clock where the read enable signal /REB is negated.

As described above, in order to read data from the external memory 50 of the NAND interface, the data can be read successively from the read start address each time the read enable signal /REB is asserted. However, when the read operation reaches the end of a page, the ready/busy signal RDY_BSYB indicates a low level (busy) again, and the read operation is halted until the ready/busy signal RDY_BSYB indicates a high level (ready).

In this case, the period “Trd” indicates the delay time of asserting the read enable signal /REB from the first cycle of the read cycle. On the other hand, the period “Trpw” indicates the length of the period of asserting the read enable signal /REB.

As has been discussed above, in the case of the present embodiment, the CPU 5 is provided with both the functionality of issuing an external bus access request directly to the external memory interface 3 and the functionality of issuing a DMA transfer request to the DMAC 4. Accordingly, in the case where data is randomly accessed at discrete addresses, an external bus access request is issued directly to the external memory interface 3, and in the case of data block transfer or page swapping as requested by a virtual memory management unit or the like, a DMA transfer request is issued to the DMAC 4 so that it is possible to effectively access the external memory 50.

In addition to this, the IPL 35, the CPU 5 and the DMAC 4 in accordance with the present embodiment only issue external bus access requests to the external memory interface 3, and the mechanism of reading and writing data is provided in the external memory interface 3. Accordingly, even in the case where different types of memory interfaces are supported, each of the IPL 35, the CPU 5 and the DMAC 4 need not be provided with a plurality of memory interfaces. Because of this, it is possible to simplify the circuit configuration and reduce the cost.

Incidentally, even in the case of the prior art multiprocessors, an external memory interface is shared by a plurality of processor cores, but the mechanism of reading and writing data is provided in each of the processor cores. Accordingly, in order to makes it possible to connect with external memories which are accessible by entirely different access methods such as a NOR interface and a NAND interface, each processor core has to be provided with a plurality of different memory interfaces. Under such circumstances, the circuit configuration becomes complicated, and the cost cannot be reduced.

Furthermore, in the case of the present embodiment, since the channel for accessing the shared main RAM 25 (i.e., the main RAM access arbiter 23) and the channel for controlling the function units (i.e., the I/O bus 27) are separated from each other, it is possible to prevent the bus bandwidth of the main RAM 25 from being wasted due to the operations of controlling the function units.

In this case, since the function units are controlled by the CPU 5 through the I/O bus 27 and the CPU 5 decodes and executes program instructions, it is possible to dynamically control the respective function units by software.

Furthermore, in the case of the present embodiment, there are the three request buffers 105, 109 and 113 for saving three DMA transfer requests issued by the CPU 5, the RPU 9 and the SPU 13, as well as the DMA request queue 45 having four entries. Accordingly, even during performing DMA transfer, another DMA transfer request can be accepted. Particularly, this is effective in the case where there is only one DMA channel.

Furthermore, in the case of the present embodiment, when the request for fetching the instruction by the CPU 5 is waited for 10 microseconds or longer while an arbitration priority ranking control register to be described below is set to “priority ranking change enabled”, the external memory interface 3 refers to the EBI priority level table shown in FIG. 3(b) rather than FIG. 3(a). Accordingly, it is avoided that the CPU 5 waits for a long time after issuing the request for fetching the instruction. In addition to this, by accessing the arbitration priority ranking control register, the CPU 5 can dynamically make a setting as to whether arbitration is performed by fixedly using only one priority level table or switchingly using one of the two priority level tables.

Furthermore, in the case of the present embodiment, since the address space of the external bus 51 is divided into the primary memory area and the secondary memory area, it is possible to make the setting of the type of the external memory to be connected thereto for each area, and thereby a plurality of different types of the external memory can be connected. Also, since the data bus width of the external bus 51 can be set for each area, a plurality of external memories having different data bus widths can be connected. Furthermore, since the timing for accessing the external memory can be set for each area, a plurality of external memories having different access timings can be connected.

Still further, as illustrated in FIG. 4, each of the primary memory area and the secondary memory area is provided with the memory type register and the access timing register. Accordingly, the CPU 5 can dynamically set, for each area, the type of the external memory 50, the data bus width of the external bus 51 and the timing for accessing the external memory 50. Also, since there is the secondary memory start address register, the CPU 5 can dynamically set the boundary between the areas.

Next, the data decompressing DMA transfer will be explained in detail.

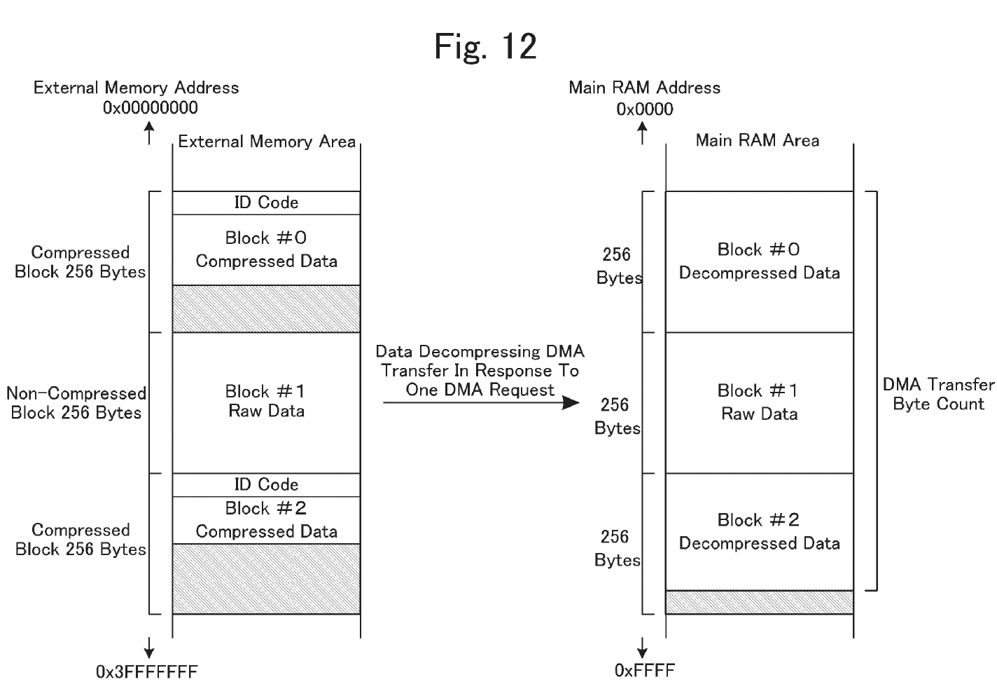

FIG. 12 is an explanatory view for showing the data decompressing DMA transfer in response to one DMA transfer request. Referring to FIG. 12, the compression of the transfer source data is compressed on a block-by-block basis in the external memory address in which 256 bytes=1 block. In the example shown in FIG. 4, the source data comprises three block #0 to #2. The block #0 and the block #2 are compressed blocks (i.e., the compressed data), and the block #1 is a non-compressed block (i.e., the raw data). The raw data is data which is not compressed.

Each of the block #0 and the block #2 includes a compressed block identification code (hereinafter referred to as “ID code”) in the leading two bytes. Accordingly, the DMA execution unit 46 compares the leading two bytes of each block with the ID code stored in a compressed block identification register 62 (that is, the DMA data decompression ID register shown in FIG. 7), and if they match it is determined that the block is a compressed block, and the DMA transfer is performed while decompressing data by the decompression circuit 48. On the other hand, if they do not match it is determined that the block is a non-compressed block, and the DMA transfer is performed without decompressing data.

Accordingly, the compressed blocks #0 and #2 are decompressed during DMA transfer, and the decompressed data is stored in the main RAM 25. On the other hand, the non-compressed block #1 is transferred as it is, and the raw data is stored in the main RAM 25. As has been discussed above, it is possible to DMA transfer compressed and non-compressed blocks together in response to one DMA transfer request.

The data hatched in the figure is a data portion which is not used in the data decompressing DMA transfer, and it is possible to improve space efficiency of the external memory 50 by storing raw data therein.

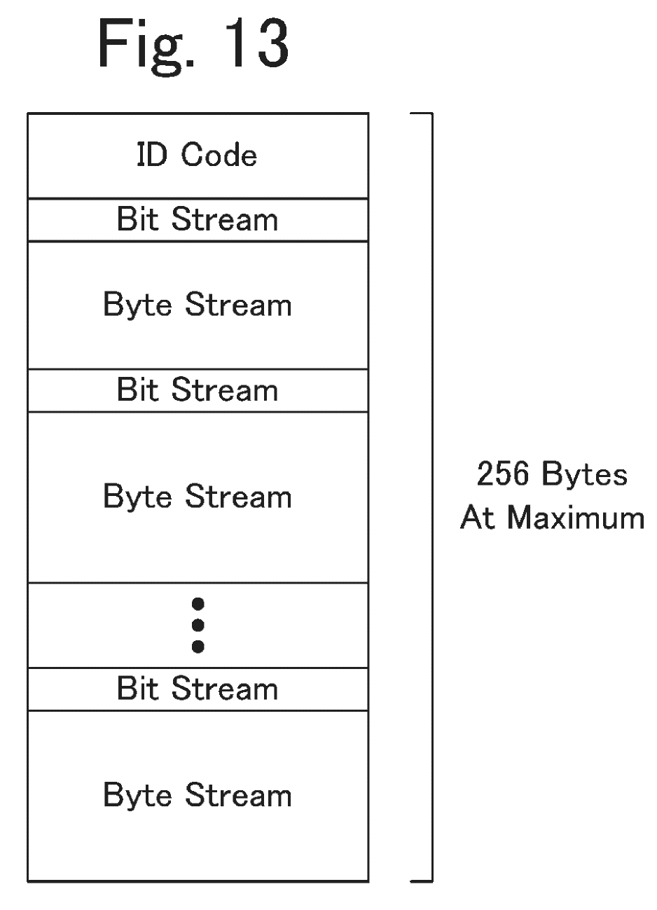

FIG. 13 is a view showing the structure of the compressed block of FIG. 12. Referring to FIG. 13, the ID code is located in the leading two bytes of the compressed block. Following the ID code, there are bit streams and byte streams which are alternately disposed. Each of the bit streams consists of 8 bits (=1 byte), and each of the byte streams is any size of 1 to 8 bytes. The size of a compressed block is up to a maximum of 256 bytes.

In this description, the data compression will briefly be explained in advance of explaining the details of the bit streams and byte streams of the compressed block. As described above, the compression algorithm used in the present embodiment is LZ77. LZ77 is called also as a slide dictionary method, which is an algorithm of performing compression by searching data sequences, which are registered in a dictionary (i.e., which occur before), for a data sequence which longest-matches the data sequence to be encoded, and replacing the data sequence to be encoded with the position information (hereinafter referred to as “matching position information”) and the length information (hereinafter referred to as “matching length information”) of the matching data sequence. In addition to this, in the case of the present embodiment, the compression rate is increased by making use of a variable-length code encoding of the matching length information generated on the basis of a slide dictionary method. The example of the variable-length code encoding used in accordance with the present embodiment is Huffman coding.

Returning to FIG. 13, a byte stream includes raw data and matching position information, and a bit stream includes a compression/non-compression flag indicative of compression or non-compression, and matching length information which is encoded by Huffman coding.

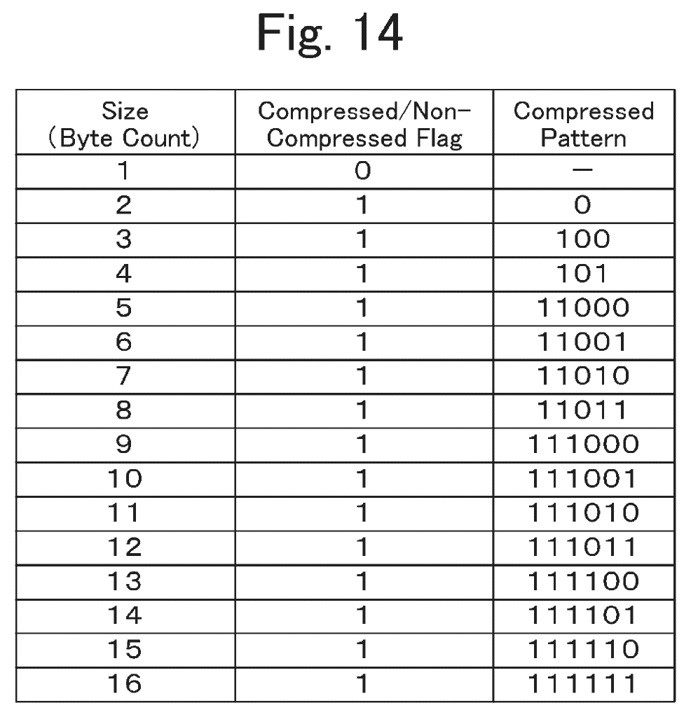

FIG. 14 is an explanatory view for showing assignment of codes when performing Huffman coding of the matching length information. Referring to FIG. 14, if the compression/non-compression flag included the bit stream is “0”, it means that the data is not compressed, i.e., raw data. The size of raw data is fixed to one byte, and thereby if the compression/non-compression flag is “0”, the size of raw data is one byte.

If the compression/non-compression flag included the bit stream is “1”, it means that the data is compressed. In this case, the bit stream includes the bit “1” followed by matching length information which is Huffman encoded. While the matching length information indicates the size of a matching data sequence in bytes before compression, as illustrated in FIG. 14, the size of the matching data sequence before compression is encoded into variable-length bit data of 1 to 6 bits in accordance with the size.

In this case, (table 1) is an exemplary expression of a compressed data sequence in the C Language representing “namamugi namagome namatamago” (a special terminating character such as the null character is not included). Incidentally, one character is represented by one bype.

TABLE 1

struct record = {

| | | |
|---|---|---|
| short | id_code; | /* 2-byte ID code */ |
| char | 0b00010000; | |
| char | ‘n’,‘a’,‘m’; | |
| char | 1; | |
| char | ‘u’,‘g’,‘i’; | |
| char | 0b01101000; | |
| char | ‘ ’; | |
| char | 8; | |
| char | ‘g’,‘o’,‘m’; | |
| char | 0b01110000; | |
| char | ‘e’; | |
| char | 8; | |
| char | ‘t’; | |
| char | 0b11100000; | |
| char | 12; | |

};

As illustrated in (table 1), the one byte data (0b00010000) stored following the ID code of the leading two bytes is a bit stream (refer to FIG. 13) which is decomposed into 7 fields, i.e., “0”, “0”, “0”, “10”, “0”, “0” and “0” from the MSB. The respective fields of “0” are a compression/non-compression flag indicative of non-compression; the bit “1” of the field “10” is a compression/non-compression flag indicative of compression; and the bit “0” of the field “10” is a Huffman code indicative of the size of a matching data sequence before compression. As understood from FIG. 14, the Huffman code of “0” indicates that the size of the matching data sequence before compression is 2 bytes.

Accordingly, this bit stream indicates that there is stored, as a subsequent byte stream (refer to FIG. 13), raw data of 3 bytes, matching position information pointing to the data of 2 bytes (the size before compression) corresponding to the compressed data, and raw data of 3 bytes.

This bit stream is followed by a byte stream which includes “n”, “a”, “m”, “1”, “u”, “g” and “i” each of which is raw data or matching position information. The data of “n”, “a” and “m” is raw data. The subsequent data “1” is matching position information indicative of the position of the compressed 2-byte data.

The matching position information “N” (a natural number) indicates that the first byte of the matching data sequence is located in the position that is “N” bytes before the “0” position, where if the preceding data is raw data, the “0” position is the position of the raw data, and if the preceding data is compressed data the “0” position is the position of the last byte of the decompressed data. In the above example, the matching position information “1” indicates that since the position of the preceding decompressed data “m” is counted as “0”, the first element “a” of the matching data sequence “am” is located one byte before.

Accordingly, decompression can be performed by acquiring the number of bytes indicated by the matching length information, as data sequence, from the start position of the matching data sequence indicated by the matching position information “N”. In the above example, decompression can be performed by extracting the data sequence “am” of 2 bytes indicated by the matching length information “0” from the start position of the matching data sequence indicated by the matching position information “1”.

The matching length information “1” is followed by “u”, “g” and “i” which are raw data. Thereafter, bit streams and byte streams are alternately stored in the compressed block in the same manner.

Then, the DMAC 4 will next be explained in detail.

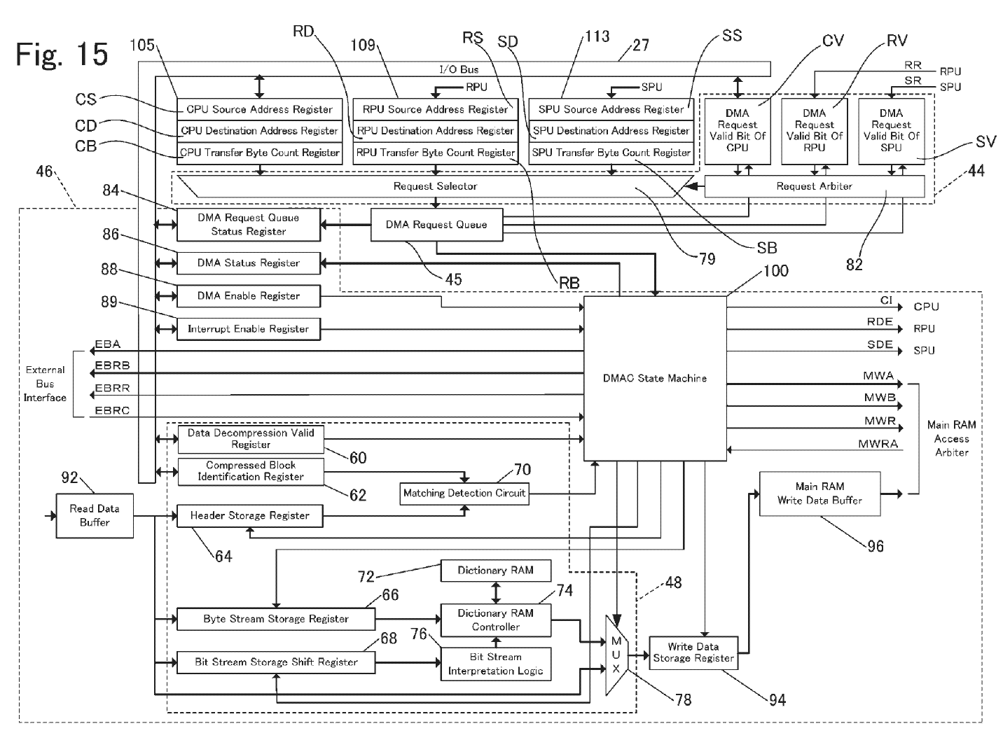

FIG. 15 is a block diagram showing the details of the internal configuration of the DMAC 4. As illustrated in FIG. 15, the DMAC 4 includes the request buffers 105, 109 and 113, the DMA request arbiter 44, the DMA request queue 45 and the DMA execution unit 46.

The request buffer 105 includes a CPU source address register CS (i.e., the DMA transfer source address register of FIG. 7), a CPU destination address register CD (i.e., the DMA destination address register of FIG. 7) and a CPU transfer byte count register CB (i.e., the DMA transfer byte count register of FIG. 7). The request buffer 109 includes an RPU source address register RS, an RPU destination address register RD and an RPU transfer byte count register RB. The request buffer 113 includes an SPU source address register SS, an SPU destination address register SD and an SPU transfer byte count register SB.

The DMA request arbiter 44 includes a request selector 79, a request arbiter 82 and a DMA request valid bit CV (i.e., the DMA start bit of the DMA control register of FIG. 7), RV and SV.

The DMA execution unit 46 includes a DMAC state machine 100, an decompression circuit 48, a DMA request queue status register 84 (i.e., the request queue busy bit of the DMA status register of FIG. 7), a DMA status register 86 (i.e., the DMA completion bit, the DMA in-progress bit and the DMA unfinished count field of the DMA status register of FIG. 7), a DMA enable register 88 (i.e., the DMA transfer enable bit of the DMA control register of FIG. 7), an interrupt enable register 89 (i.e., the interrupt enable bit of the DMA control register of FIG. 7), a read data buffer 92, a write data storage register 94 and the main RAM write data buffer 96.

The decompression circuit 48 includes a data decompression valid register 60 (i.e., a data decompression enable bit included in the DMA data decompression control register of FIG. 7), a compressed block identification register 62 (i.e., the DMA data decompression ID register of FIG. 7), a header storage register 64, a matching detection circuit 70, a byte stream storage register 66, a bit stream storage shift register 68, a dictionary RAM 72, a dictionary RAM controller 74, a bit stream interpretation logic 76 and a multiplexer (MUX) 78.

Three function units, i.e., the CPU 5, the RPU 9 and the SPU 13, issue DMA transfer requests to the DMAC 4. The DMA transfer request from the CPU 5 is issued through the I/O bus 27. More specifically speaking, the CPU 5 writes “a source address”, “a destination address” and “a number of transfer bytes” respectively to the CPU source address register CS, the CPU destination address register CD and the CPU transfer byte count register CB through the I/O bus 27. Then, the DMA transfer request from the CPU 5 becomes valid when the CPU 5 writes “1” to the DMA request valid bit CV which is provided corresponding to the CPU 5.

When a DMA transfer request is issued from the RPU 9, a “source address”, a “destination address”, a “number of transfer bytes” and a DMA transfer request signal RR are directly input to the DMAC 4. More specifically speaking, the RPU 9 asserts the DMA transfer request signal RR, and in response to this, the “source address”, the “destination address” and the “number of transfer bytes” input by the RPU 9 are stored respectively in the RPU source address register RS, the RPU destination address register RD and the RPU transfer byte count register RB, while the value of the DMA request valid bit RV provided corresponding to the RPU 9 is set to “1”. By this process, the DMA transfer request from the RPU 9 becomes valid.

When a DMA transfer request is issued from the SPU 13, a “source address”, a “destination address”, a “number of transfer bytes” and a DMA transfer request signal SR are directly input to the DMAC 4. More specifically speaking, the SPU 13 asserts the DMA transfer request signal SR, and in response to this, the “source address”, the “destination address” and the “number of transfer bytes” input by the SPU 13 are stored respectively in the SPU source address register SS, the SPU destination address register SD and the SPU transfer byte count register SB, while the value of the DMA request valid bit SV provided corresponding to the SPU 13 is set to “1”. By this process, the DMA transfer request from the SPU 13 becomes valid.

The request arbiter 82 outputs a selection signal to the request selector 79 in order that, when only a single DMA transfer request is valid, the single DMA transfer request is selected, and when a plurality of DMA transfer requests is valid, the DMA transfer request having the highest priority among the valid DMA transfer requests is selected in accordance with the DMA priority level table of FIG. 6.

The request selector 79 outputs, to the DMA request queue 45, the “source address”, the “destination address” and the “number of transfer bytes” stored in the request buffer 105, 109 or 113 corresponding to the DMA transfer request selected by the selection signal which is output from the request arbiter 82.

The DMA request queue 45 is a buffer of an FIFO structure for outputting DMA transfer requests, which are input from the request buffers, in the order of the reception thereof. More specific description is as follows.

The “source address”, the “destination address”, and the “number of transfer bytes” which are input from the request buffer are stored as a DMA transfer request in the DMA request queue 45 as well as the information indicative of which of the function units (the CPU 5/the RPU 9/the SPU 13) issues the request.

When a DMA transfer request is accepted, the DMA request queue 45 clears the value of the DMA request valid bit CV, RV or SV to “0” corresponding to the functional unit 5, 9 or 13 which issues the DMA transfer request, so that the function unit can issue a DMA transfer request anew. On the other hand, the DMA request queue 45 does not accept a new DMA transfer request when the queue is in a busy (full) state.

Also, the DMA request queue 45 reflects the state of the queue (busy/ready) in the DMA request queue status register 84. The DMA request queue status register 84 can be accessed by the CPU 5 through the I/O bus 27. The CPU 5 can know the status of the DMA request queue 45 by reading this register 84 and determine whether or not a new DMA transfer request can be issued.

The DMA transfer request (the “source address”, the “destination address”, the “number of transfer bytes” and the information indicative of which of the function units issues the request) as output from the DMA request queue 45 is input to the DMAC state machine 100. The DMAC state machine 100 generates an external bus read request signal EBRR, an external bus address EBA and an external bus read byte count signal EBRB on the basis of the DMA transfer request as input, and outputs the external bus read request signal EBRR, the external bus address EBA and the external bus read byte count signal EBRB to the external memory interface 3 as an external bus access request.

If the external bus access request as the external bus read request signal EBRR is accepted, the read data from the external memory 50 is successively input to the DMAC 4 from the external memory interface 3. The read data as input is successively stored in the read data buffer 92, and the external bus read count signal EBRC is asserted each time one byte/word is input. The external bus read count signal EBRC is input to the DMAC state machine 100, so that the DMAC state machine 100 can be informed of the number of bytes which have been read at the current time.

When the value of the data decompression valid register 60 for controlling the data decompression to be enabled/disabled is set to “1” (i.e., when the data decompression is enabled), the DMAC state machine 100 stores the read data of 2 bytes whose lower 8 bit addresses of the external bus address are 0x00 and 0x01 respectively in both the header storage register 64 and the write data storage register 94. In this case, the DMAC state machine 100 outputs a selection signal for selecting the data from the read data buffer 92 to the multiplexer 78, and in response to this, the 2-byte read data from the read data buffer 92 is stored in the write data storage register 94.

The matching detection circuit 70 compares the value of the 2-byte data stored in the header storage register 64 and the value of the 2-byte data (ID code) stored in the compressed block identification register 62, and if the two values match the DMAC state machine 100 is notified of this fact. When receiving this notification, the DMAC state machine 100 considers the data of subsequent K bytes (which may take on 2 to 254 bytes) as a compressed block, and successively stores the data in the bit stream storage shift register 68 or the byte stream storage register 66. In this case, the bit stream of the compressed block is stored in the bit stream storage shift register 68, and the byte stream of the compressed block is stored in the byte stream storage register 66.

On the other hand, when the matching detection circuit 70 compares the value of the 2-byte data stored in the header storage register 64 and the value of the 2-byte data (ID code) stored in the compressed block identification register 62, if the two values do not match, the DMAC state machine 100 is notified of this fact. When receiving this notification, the DMAC state machine 100 considers the data of 256 bytes inclusive of the two bytes stored in the header storage register 64 as a non-compressed block. Then, the DMAC state machine 100 treats the data of 2 bytes stored in the write data storage register 94 as valid write data. Furthermore, subsequent to this, the data input to the read data buffer 92 is successively input to the write data storage register 94 until the lower 8 bits of the external bus address is returned to 0x00, while each time data of 8 bytes is accumulated in the write data storage register 94 the data is output to the main RAM write data buffer 96. However, when all the data as requested has been read before the lower 8 bits of the external bus address is returned to 0x00, the data stored in the write data storage register 94 at that time is output to the main RAM write data buffer 96 even if data of 8 bytes is not accumulated in the write data storage register 94.

The bit stream stored in the bit stream storage shift register 68 is output to the bit stream interpretation logic 76 on a bit-by-bit basis. The bit stream interpretation logic 76 successively interprets the bit stream as input, and decompresses the compressed data by controlling the dictionary RAM controller 74.

More specifically speaking, when the bit as received, i.e., the compression/non-compression flag indicates “0” (non-compression), the bit stream interpretation logic 76 notifies the dictionary RAM controller 74 of this fact. The dictionary RAM controller 74 which receives this notification writes one byte data (raw data) as input from the byte stream storage register 66 to the dictionary RAM 72, and outputs the data to the multiplexer 78 as decompressed data.

On the other hand, when the bit as received, i.e., the compression/non-compression flag indicates “1” (compression), the bit stream interpretation logic 76 decodes the matching length information which is Huffman encoded and successively input, and outputs the matching length information to the dictionary RAM controller 74. The dictionary RAM controller 74 reads a matching data sequence from the byte stream storage register 66 on the basis of the matching length information which is received from the bit stream interpretation logic 76 and the matching position information which is received from the byte stream storage register 66, and the matching data sequence is output to the multiplexer 78 as decompressed data and written to the dictionary RAM 72 as new decompressed data.

When the value of the data decompression valid register 60 is set to “1” (i.e., when the data decompression is enabled), the DMAC state machine 100 outputs the selection signal for selecting the decompressed data from the dictionary RAM controller 74 to the multiplexer 78. Accordingly, in this case, the decompressed data as output from the dictionary RAM controller 74 is successively stored in the write data storage register 94. At this time, the 2-byte read data (the read data of 2 bytes whose lower 8 bit addresses of the external bus address are 0x00 and 0x01) stored in the write data storage register 94 in advance is discarded, and overwritten with the decompressed data which is output from the dictionary RAM controller 74. On the other hand, in the case where the value of the data decompression valid register 60 is set to “0” (i.e., when the data decompression is disabled), the DMAC state machine 100 outputs the selection signal for selecting the data from the read data buffer 92 to the multiplexer 78. The CPU 5 can read/write the data stored in the data decompression valid register 60 through the I/O bus 27.

The dictionary RAM 72 has a capacity of 256×8 bits, and the latest 256 bytes of the decompressed data is always stored therein under the control by the dictionary RAM controller 74.

Each time data of 8 bytes is accumulated, the write data storage register 94 outputs the accumulated data to the main RAM write data buffer 96. The main RAM write data buffer 96 outputs the data as received to the main RAM access arbiter 23. In this case, if the number of bytes to be transferred to the main RAM access arbiter 23 cannot be divided by “8”, the residue as the last data is output to the main RAM write data buffer 96 even if data of 8 bytes is not accumulated in the write data storage register 94. Incidentally, the number of transfer bytes is represented by the number of bytes after data decompression.

The DMAC state machine calculates a main RAM write address MWA, a main RAM write byte count MWB (1 to 8 bytes) on the basis of the destination address and the number of transfer bytes as input from the DMA request queue 45, and outputs them to the main RAM access arbiter 23 together with a main RAM write request signal MWR.

When a write request issued as the main RAM write request signal MWR is accepted, a main RAM write request acknowledge signal MWRA is input from the main RAM access arbiter 23. When receiving the main RAM write request acknowledge signal MWRA, the DMAC state machine 100 enters the next state for writing data. Meanwhile, when all the number of bytes as requested have been completely DMA transferred, the DMAC state machine 100 outputs an RPU requested DMA completion signal RDE to the RPU 9 for notifying the completion in response to the DMA transfer request from the RPU 9, or outputs an SPU requested DMA completion signal SDE to the SPU 13 for notifying the completion in response to the DMA transfer request from the SPU 13.

The state of the DMAC state machine 100 is reflected in the DMA status register 86. The DMA status register 86 includes the DMA completion bit, the DMA in-progress bit and the DMA unfinished count field. The DMA completion bit is set to “1” each time the DMA transfer as requested by the CPU 5 is completed. In the case where the interrupt enable bit stored in the interrupt enable register 89 is set to the enable state, the DMAC state machine 100 issues an interrupt request CI to the CPU 5 at the same time as the DMA completion bit is set to “1”. The DMA in-progress bit is a bit indicative of whether or not the DMA transfer request is in progress. The DMA unfinished count field is a field indicative of the number of the DMA transfer requests which are issued from the CPU 5 and have not been finished yet. The CPU 5 reads the value of the DMA status register 86 through the I/O bus 27 so that the current state of the DMAC 4 can be known.

The DMA enable register 88 is used to store the DMA transfer enable bit. The DMA transfer enable bit is a bit for controlling DMA transfer requested by the CPU 5 to be enabled/disabled. The CPU 5 can read/write the data stored in the DMA enable register 88 and the interrupt enable register 89 through the I/O bus 27.

By the way, as has been discussed above, since the DMAC 4 is provided with data decompression functionality in the case of the present embodiment, it is possible to store the data (inclusive of program codes) to be transferred to the main RAM 25 as compressed data in the external memory 50. As a result, it is possible to reduce the capacity of the external memory 50. In addition to this, since the DMAC 4 is provided with the data decompression functionality, it is possible to transmit data from the external memory 50 to the external bus 51 as compressed data in response to the DMA transfer request from the CPU 5. Accordingly, it is possible to reduce the external bus bandwidth which is consumed by the CPU 5. Accordingly, it is possible to increase the length of time which can be spared for the other function unit (the CPU 5, the RPU 9 or the SPU 13) to use the external bus 51, and shorten the latency until the other function unit gets a bus use permission.

In addition to this, since compressed data and non-compressed data can be mixed in transferring data during one DMA transfer process, it is possible to reduce the number of times of issuing a DMA transfer request as compared with the case where separate DMA transfer requests have to be issued for compressed data and non-compressed data respectively. Accordingly, it is possible to reduce the processing load relating to the DMA transfer request of the CPU 5, and thereby to use the capacity of the CPU 5 for performing other processes. Because of this, the total performance of the CPU 5 can be enhanced. Furthermore, since a program can be written without managing compressed data and non-compressed data in distinction from each other, it is possible to lessen the burden on the programmer.

While all the data may be compressed for DMA transfer, there is some data which is compressed only at a low compression rate so that little advantage is expected by the compression. Even if such data is compressed, not only little advantage but also the processing load increased due to the decompression process, are expected. Accordingly, by making it possible to mix compressed data and non-compressed data, it is possible not only to improve the total performance of the CPU 5 but also to improve the total performance of the DMAC 4 itself.

Furthermore, since the DMAC 4 performs DMA transfer while performing data decompression (in a concurrent manner), the CPU 5 need not perform the decompression process so that the load on the CPU 5 can be decreased. In addition to this, since the data transfer to the main RAM 25 is performed while performing data decompression, it is possible to speed up the data transfer as compared with the case where the data transfer is performed after the completion of data decompression.

Furthermore, in accordance with the present embodiment, if there is a code which matches the ID code in a block (refer to FIG. 12), the compressed data contained in the block is transmitted to the decompression circuit 48 in which the compressed data is decompressed. Accordingly, even if compressed data and non-compressed data is mixed, it is easy to separate the compressed data and the non-compressed data only by inserting the ID code in the block.

Since the ID code is stored in the compressed block identification register 62 which can be rewritten by the CPU 5, it is possible to dynamically change the ID code during running software. Even in the case where there are a substantial number of blocks containing non-compressed data so that it is impossible to select an ID code which is not contained in any block containing non-compressed data, it is possible to mix compressed data and non-compressed data with no problem by dynamically changing the ID code.

Furthermore, in the case of the present embodiment, Huffman coding is used in addition to the compression on the basis of LZ77. Accordingly, it is possible to increase the compression rate of the data stored in the external memory 50.

Furthermore, since the decompression process is performed only for the DMA transfer request issued from the CPU 5 in the case of the present embodiment, it is possible to avoid an unnecessary increase in the processing load for decompression and thereby to prevent the process from being delayed.

Furthermore, since there are the request buffers 105, 109 and 113 corresponding to the CPU 5, the RPU 9 and the SPU 13 respectively in the case of the present embodiment, it is possible to arbitrate DMA transfer requests in the DMAC 4. Accordingly, the external memory interface 3 which arbitrates external bus access requests need not perform the arbitration of DMA transfer requests, but in regard to the arbitration process it is responsible only for performing the arbitration of external bus access requests, such that it is possible to lessen the system overhead. In other words, the overhead is lessened by performing dispersed and parallel processing for arbitration process.

Next, the external interface block 21 of FIG. 1 will be explained in detail.

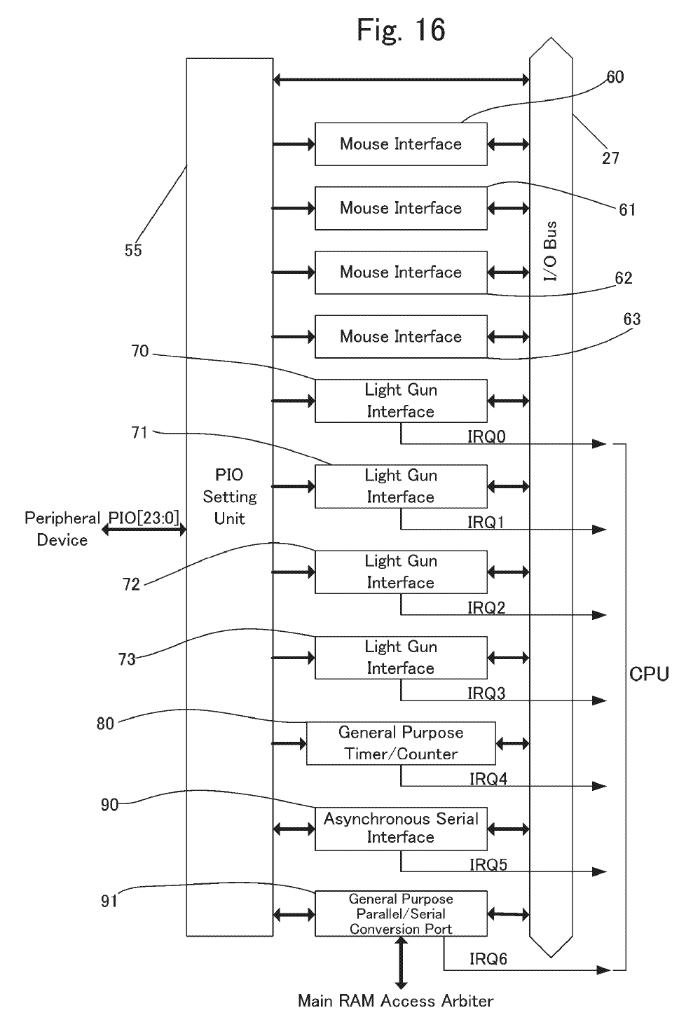

FIG. 16 is a block diagram showing the internal configuration of the external interface block 21 of FIG. 1. As illustrated in FIG. 16, the external interface block 21 includes a PIO setting unit 55, mouse interfaces 60 to 63, light gun interfaces 70 to 73, a general purpose timer/counter 80, an asynchronous serial interface 90, and a general purpose parallel/serial conversion port 91.

The PIO setting unit 55 is a function block for performing the various settings of the PIO 0 to PIO 23 which are ports of input/output signals between the peripheral devices 54 and the multimedia processor 1. The PIO setting unit 55 sets each of the PIOs with respect to whether the port is used as an input port or an output port, whether or not there is an internal pull-up resistance, and whether or not there is an internal pull-down resistance. Also, the PIO setting unit 55 performs the settings with respect to the connection/disconnection of the respective PIOs with the respective functions 60 to 63, 70 to 73, 80, 90 and 91. The CPU 5 makes these settings by rewriting the values of the control registers (not shown in the figure) in the PIO setting unit 55 through the I/O bus 27.

Each of the mouse interfaces 60 to 63 is a function block which is used for connection with a pointing device such an a mouse and a track ball. The mouse interfaces 60 to 63 serve to provide four channels, and can be connected with a maximum of four devices such as mice.

Each of the mouse interfaces 60 to 63 is connected to four PIOs, which are set up as input ports corresponding to the mouse interface, and two of the four PIOs are provided for X-axis and the other two are provided for the Y-axis. Then, for each of the X-axis and Y-axis, two rotary encoder signals are input with a 90 degree phase shift therebetween. Each of the mouse interfaces 60 to 63 detects the phase change between the rotary encoder signals and increments/decrements counters provided respectively for the X-axis and Y-axis. The counter value of this counter is read by the CPU 5 through the I/O bus 27. Also, the counter value of this counter can be rewritten by the CPU 5 through the I/O bus 27.

Each of the light gun interfaces 70 to 73 is a function block which is used for connecting with a pointing device such as a light pen or light gun for a CRT (Braun tube). The light gun interfaces 70 to 73 serve to provide four channels, and connect with a maximum of four devices such as light guns at a maximum.

Each of the light gun interfaces 70 to 73 is connected to one PIO, which is set up as an input port corresponding to that interface. Then, when one of the light gun interfaces 70 to 73 detects the rising edge (transition from a low level to a high level) of the signal which is input from the corresponding PIO, the value of a horizontal counter is latched in the RPU 9, and at the same time the one of the light gun interfaces 70 to 73 detecting the rising edge issues a corresponding one of the interrupt request signals IRQ0 to IRQ3 to the CPU 5.

During the interrupt process invoked by one of the light gun interfaces 70 to 73, by reading the current value of a vertical counter provided in the RPU 9 and the value of the horizontal counter as latched, the CPU 5 can know the values of the vertical counter and horizontal counter, which are taken when the rising edge of the input signal is detected. In other words, the CPU 5 can know what position the device such as a light gun points to in the screen of the CRT.

In this case, it is also possible to modify the system in order that, at the falling edge (transition from a high level to a low level) rather than the rising edge, the horizontal count is latched and the interrupt request signals IRQ0 to IRQ3 are issued. The setting of rising or falling edge, the setting of enabling or disabling the issue of the interrupt request signals IRQ0 to IRQ3, and the operation of reading the value of the horizontal counter are performed by the CPU 5 which accesses control registers (not shown in the figure) in the light gun interfaces 70 to 73 through the I/O bus 27.

The general purpose timer/counter 80 includes a programmable 2-channel timer/counter which can be used for a variety of purposes. Each channel of the timer/counter functions as a timer when it is driven by the system clock in the multimedia processor 1, and functions as a counter when it is driven by the input signal from a PIO (for example, PIO 6) which is set as an input port.

It is possible to make separate settings for the two channels of the timer/counter respectively. When the counter value of this timer/counter reaches a predetermined value, the interrupt request signal IRQ4 can be issued to the CPU 5.

The setting of whether it serves as a timer or counter, the setting of the predetermined counter value, and the setting of enabling or disabling the issue of the interrupt request signal IRQ4 are performed by the CPU 5 which accesses control registers (not shown in the figure) in the general purpose timer/counter 80 through the I/O bus 27.

The asynchronous serial interface 90 is a serial interface capable of performing full duplex asynchronous serial data communications. The term “full duplex” means a system capable of both transmitting and receiving data at the same time, and the term “asynchronous” means a system capable of synchronizing the incoming data by the use of start and stop bits without using a clock signal for synchronization. The communication method of the asynchronous serial interface 90 is compatible with UART (Universal Asynchronous Receiver Transmitter) which is used for serial input/output ports of personal computers.

The data to be transmitted to an external device is written to a transmission buffer (not shown in the figure) of the asynchronous serial interface 90 by the CPU 5 through the I/O bus 27. The transmission data written to the transmission buffer is converted from parallel data into a serial data sequence by the asynchronous serial interface 90, and output on a bit-by-bit basis from a PIO (for example, the PIO 2) which is set as an output port.

On the other hand, the external data input on a bit-by-bit basis from a PIO (for example, PIO 1), which is set as an input port, is converted from a serial data sequence into parallel data by the asynchronous serial interface 90 and written to a receiving buffer (not shown in the figure) in the asynchronous serial interface 90. The received data written to the receiving buffer is read by the CPU 5 through the I/O bus 27.

In addition to this, the asynchronous serial interface 90 is capable of issuing an interrupt request signal IRQ5 to the CPU 5 when all the data stored in a transmission buffer has been completely transmitted or when the received data has been fully stored in the receiving buffer. The operation of writing data to the transmission buffer, the operation of reading data from the receiving buffer, the setting of the communication baud rate, and the setting of enabling or disabling the issue of the interrupt request signal IRQ5 are performed by the CPU 5 which accesses control registers (not shown in the figure) in the asynchronous serial interface 90 through the I/O bus. Incidentally, the communication baud rate is expressed as the number of data modulation cycles per second, which substantially corresponds to bps (bit per second).

The general purpose parallel/serial conversion port 91 is a serial interface capable of performing half duplex serial data communications. The term “half duplex” means a system in which data transmission and data reception are not concurrently performed but communication is performed while switching between data transmission and data reception.

The transmission data which is read from a transmitting and receiving buffer SRB which is defined in the main RAM 25 is converted from parallel data into a serial data sequence by the general purpose parallel/serial conversion port 91, and output on a bit-by-bit basis from a PIO (for example, the PIO 5) which is set as an output port.

On the other hand, the received data input on a bit-by-bit basis from a PIO (for example, PIO 4), which is set as an input port, is converted from a serial data sequence into parallel data by the general purpose parallel/serial conversion port 91 and written to the transmitting and receiving buffer SRB in the main RAM 25.

As described above, since the transmitting and receiving buffer SRB in the main RAM 25 is used for both transmission and reception, it is impossible to perform transmission and reception at the same time. The operation of writing the transmission data to the transmitting and receiving buffer SRB and the operation of reading the received data from the transmitting and receiving buffer SRB are performed directly by accessing the main RAM 25 through the CPU 5.

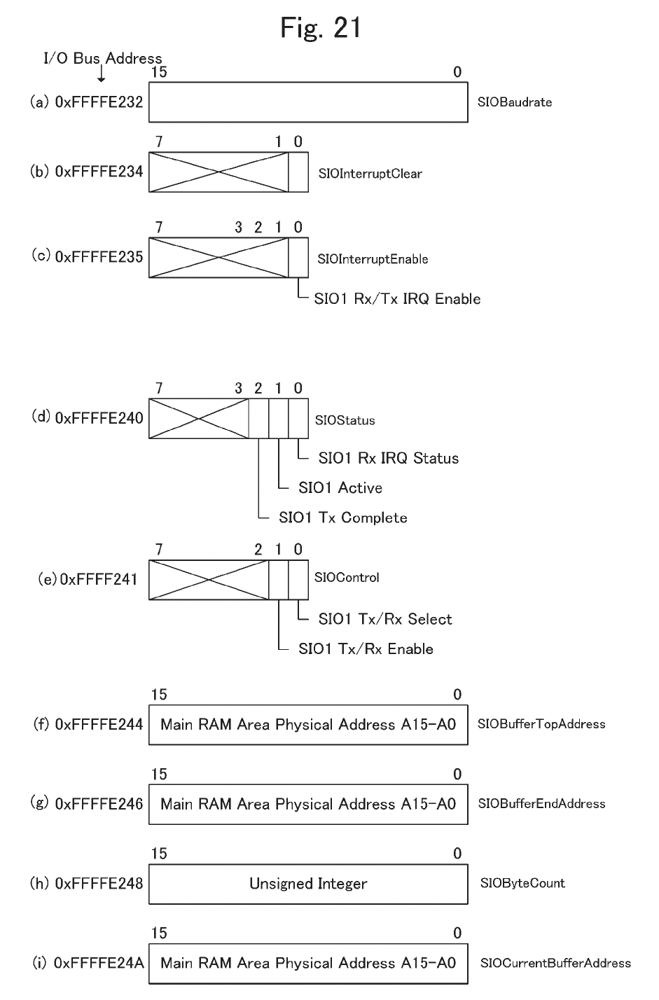

The general purpose parallel/serial conversion port 91 is capable of issuing an interrupt request signal IRQ6 to the CPU 5 when the data transmission of a predetermined number of bytes from the transmitting and receiving buffer SRB has been completed or when the received data of a predetermined number of bytes has been stored in the transmitting and receiving buffer SRB. The setting of transmission and reception, the setting of the area for the transmitting and receiving buffer SRB, the setting of the communication baud rate, and the setting of enabling or disabling the issue of the interrupt request signal IRQ6 are performed by the CPU 5 which accesses control registers (refer to FIG. 21 to be described below) in the general purpose parallel/serial conversion port 91 through the I/O bus.

As described above, the general purpose parallel/serial conversion port 91 is provided with the functionality of accessing the transmitting and receiving buffer SRB which is defined in the main RAM 25. When accessing the main RAM 25, the general purpose parallel/serial conversion port 91 issues an access request to the main RAM access arbiter 23. If the main RAM access arbiter 23 permits the access to the main RAM 25, the general purpose parallel/serial conversion port 91 actually performs the reception of read data from the main RAM 25 or the transmission of write data to the main RAM 25.

Meanwhile, in FIG. 16, the input/output signals PIO[23:0] between the PIO setting unit 55 and the peripheral devices 54 are input/output signals passed through the PIOs which are given the same names respectively.

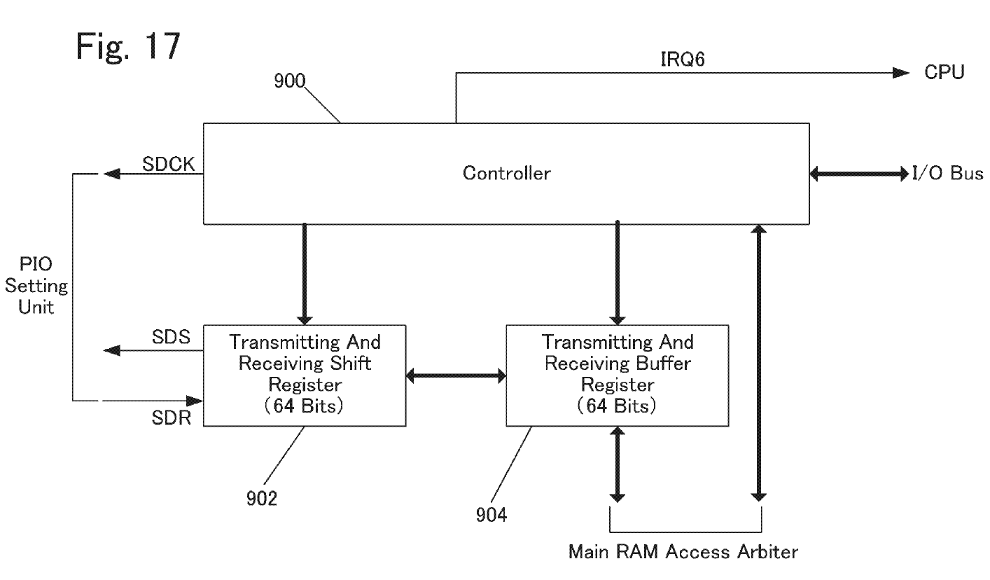

FIG. 17 is a block diagram showing the internal configuration of the general purpose parallel/serial conversion port 91 of FIG. 16. As illustrated in FIG. 17, the general purpose parallel/serial conversion port 91 includes a controller 900, a transmitting and receiving shift register 902 and a transmitting and receiving buffer resistor 904.

The controller 900 controls the transmission and reception of data by controlling the transmitting and receiving shift register 902 and the transmitting and receiving buffer resistor 904 in accordance with set values which are written to control registers (refer to FIG. 21 to be described below) by the CPU 5 through the I/O bus 27. More specific description is as follows.

The controller 900 issues an access request to the main RAM access arbiter 23 and receives an access permission from the main RAM access arbiter 23 for the purpose of writing data stored in the transmitting and receiving buffer resistor 904 to the transmitting and receiving buffer SRB in the main RAM 25, and for the purpose of storing data, which is read from the transmitting and receiving buffer SRB in the main RAM 25, in the transmitting and receiving buffer resistor 904.

In addition, when transmitting and receiving the data, the controller 900 generates a serial data clock SDCK in accordance with the communication baud rate which is set in a control register (refer to FIG. 21 to be described below), and outputs it to the PIO setting unit 55. The PIO setting unit 55 outputs the serial data clock SDCK, which is output from the controller 900, to the peripheral devices 54 through the PIO (for example, the PIO 3).

Furthermore, the controller 900 is provided with the functionality of issuing the interrupt request signal IRQ6 to the CPU 5 when the data transmission of a predetermined number of bytes has been completed or when the data reception of a predetermined number of bytes has been completed. However, the setting of enabling or disabling the issue of the interrupt request signal IRQ6 is performed by the CPU 5 which accesses a control registers (refer to FIG. 21 to be described below) through the I/O bus 27.

The transmitting and receiving buffer resistor 904 is a register having the size of 64 bits and operable under the control of the controller 900. More specific description is as follows.

In the case of data transmission, the transmitting and receiving buffer resistor 904 temporarily stores 64-bit data received from the main RAM access arbiter 23, and transfers the data as stored to the transmitting and receiving shift register 902 in the timing when the data transmission from the transmitting and receiving shift register 902 is completed. The input data to the transmitting and receiving shift register 902 is parallel data.

On the other hand, in the case of data reception, the transmitting and receiving buffer resistor 904 temporarily stores 64-bit data transferred from the transmitting and receiving shift register 902, and transfers the data as stored to the main RAM access arbiter 23 in the timing when the write operation to the main RAM 25 is permitted. The input data to the transmitting and receiving buffer resistor 904 is parallel data.

The transmitting and receiving shift register 902 is a shift register having the size of 64 bits and operable under the control of the controller 900. More specific description is as follows.

In the case of data transmission, the transmitting and receiving shift register 902 outputs 64-bit data received from the transmitting and receiving buffer resistor 904 on a bit-by-bit basis in synchronization with the serial data clock SDCK. In other words, the transmitting and receiving shift register 902 converts parallel data of 64 bits into a serial data sequence SDS, and outputs the serial data sequence.

On the other hand, in the case of data reception, the transmitting and receiving shift register 902 stores a serial data sequence SDR as received on a bit-by-bit basis by sampling in synchronization with the serial data clock SDCK, and transmits the received data to the transmitting and receiving buffer resistor 904 in the timing when the received data is accumulated as 64-bit data. In other words, the transmitting and receiving shift register 902 converts the received serial data sequence SDR into parallel data of 64 bits, and outputs the parallel data.

The transmission data (transmission serial data) SDS is output from the PIO (for example, the PIO 5) through the PIO setting unit 55, and the received data (received serial data) SDR is input from the PIO (for example, the PIO 4) through the PIO setting unit 55.

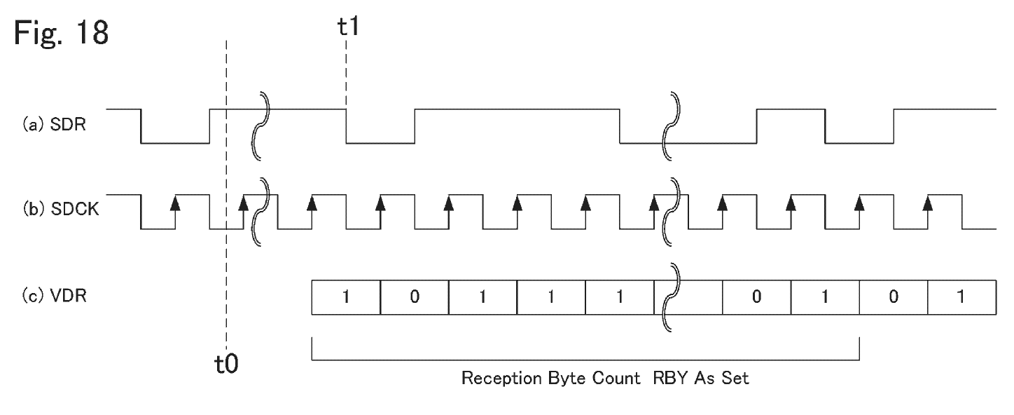

FIG. 18 is a timing chart of the data reception process which is performed by the general purpose parallel/serial conversion port 91 of FIG. 16. As shown in FIG. 18(a), the general purpose parallel/serial conversion port 91 samples the received serial data SDR in synchronization with the serial data clock SDCK of FIG. 18(b). However, the sampled data SDR is not stored in the transmitting and receiving shift register 902 in the period (before the time point “t0”) in which data reception is not set enabled in a control register (refer to FIG. 21 to be described below) provided in the general purpose parallel/serial conversion port 91. In other words, as shown in FIG. 18(c), the received data SDR before the time point “t0” at which the setting of enabling reception is made is not used as the valid received data VDR.

However, the received serial data SDR is not necessarily stored in the transmitting and receiving shift register 902 as the valid received data VDR just after the setting of enabling reception is made. The operation of inputting data to the transmitting and receiving shift register 902 as the valid received data VDR is started when a change is detected in the signal level of the received serial data SDR (from a high level to a low level or from a low level to a high level) after the setting of enabling reception is made.

In this case, the received serial data SDR actually treated as the valid received data VDR includes one bit, which is received just before a change, when the change is detected in the signal level of the received serial data SDR. In the case of FIG. 18(a), a change from a high level to a low level is detected in the received serial data SDR at the time point “t1”, the one bit of a high level (i.e., “1”) which is received just before the change is treated as the valid received data VDR.

When completely receiving the valid data VDR in correspondence with a reception byte count RBY which is preliminarily set in a control register (refer to FIG. 21 to be described below), the general purpose parallel/serial conversion port 91 can output the interrupt request signal IRQ6 to the CPU 5. However, since the data reception may be continued also after the interrupt request signal IRQ6 is output to the CPU 5, the CPU 5 has to read the received data from the transmitting and receiving buffer SRB in advance of causing the overflow of the received data from the transmitting and receiving buffer SRB in the main RAM 25. Also, while the CPU 5 can read the current number of bytes as received through the I/O bus 27, in the case where the issue of the interrupt request signal IRQ6 is set disabled, it has to read data from the transmitting and receiving buffer SRB in order to prevent buffer overrun from occurring due to the received data written to the transmitting and receiving buffer SRB by monitoring the current number of bytes as received.

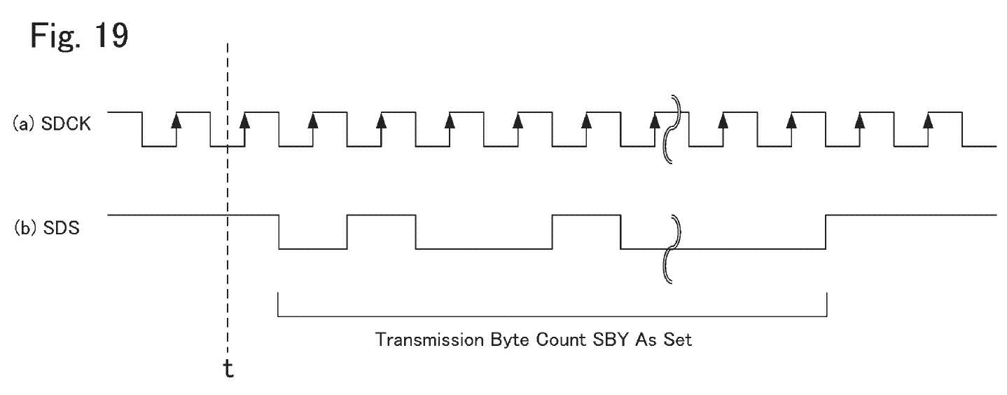

FIG. 19 is a timing chart of the data transmission process which is performed by the general purpose parallel/serial conversion port 91 of FIG. 16. As shown in FIG. 19(b), the general purpose parallel/serial conversion port 91 performs the transmission of the transmission data SDS in synchronization with the serial data clock SDCK of FIG. 19(a). However, the data transmission from a PIO (for example, the PIO 5) which is set as an output port is not performed in the period (before the time point “t”) in which data transmission is not set enabled in a control register (refer to FIG. 21 to be described below) which is provided in the general purpose parallel/serial conversion port 91. In other words, as shown in FIG. 19(b), the transmission data maintains the same level (value) before the time point “t” at which the setting of enabling transmission is made.

After the time point “t” at which the setting of enabling transmission is made, the value stored in the transmitting and receiving shift register 902 is output from a PIO (for example, the PIO 5) which is set as an output port on a bit-by-bit basis. When the output operation is completed in correspondence with a transmission byte count SBY as set, the data transmission is automatically stopped (without receiving an instruction). On the other hand, in the case where the issue of the interrupt request signal IRQ6 to the CPU 5 is set enabled, the interrupt request signal IRQ6 is output to the CPU 5 in the timing when the transmission is completed.

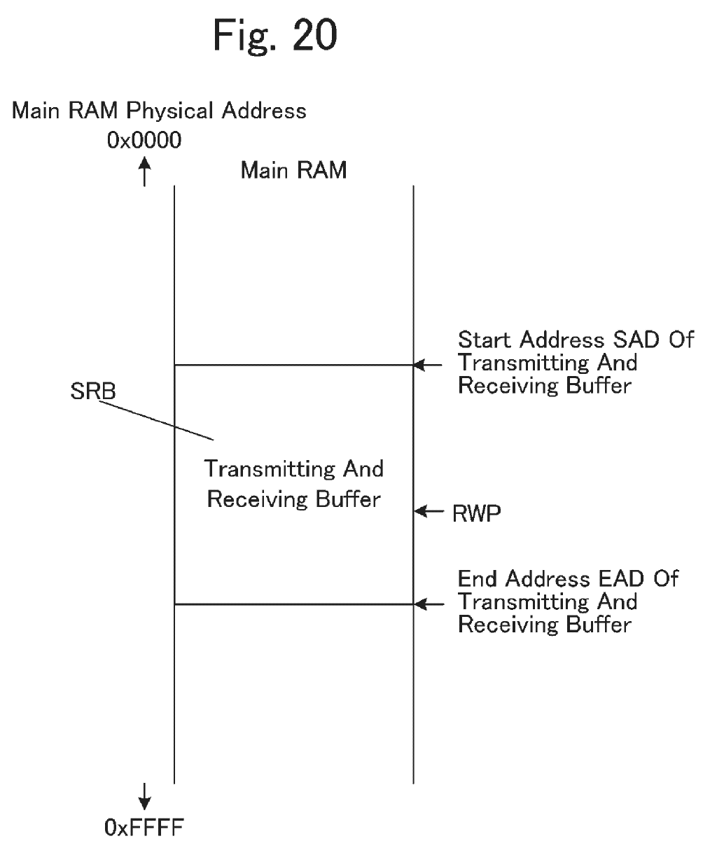

FIG. 20 is an explanatory view for showing the transmitting and receiving buffer SRB which is defined on the main RAM 25 of FIG. 1 for the general purpose parallel/serial conversion port 91. As shown in FIG. 20, the transmitting and receiving buffer SRB which is defined on the main RAM 25 is located in the physical address space of the main RAM 25. The start address SAD and end address EAD of the transmitting and receiving buffer SRB are set in control registers (refer to FIG. 21 to be described below) in the general purpose parallel/serial conversion port 91. The values of the start address SAD and end address EAD are set respectively as physical addresses of the main RAM 25. The settings are performed by the CPU 5 through the I/O bus 27.

This transmitting and receiving buffer SRB serves as a ring buffer. Namely, the read/write address pointing to the current read/write position is successively incremented, and reset to the start address SAD when the current address reaches the end address EAD. The CPU 5 can read the current value of the read address/write address pointed to by the pointer RWP through the I/O bus 27.

FIG. 21 is a view for explaining the control registers provided in association with the general purpose parallel/serial conversion port 91 of FIG. 16. The general purpose parallel/serial conversion port 91 is provided with the control registers as shown in FIG. 21. Incidentally, the respective control registers are located in the I/O bus addresses corresponding thereto in the figure.

The control register “SIOBaudrate” of FIG. 21(a) is used to set the addition data of a counter of a baud rate generator (not shown in the figure) for preparing the serial data clock SDCK which is used by the general purpose parallel/serial conversion port 91 for data transmission and reception. This corresponds to the setting of the communication baud rate. The control register “SIOInterruptClear” of FIG. 21(b) is used to clear the cause of the interrupt of the general purpose parallel/serial conversion port 91 by writing “1” to the zeroth bit. In other words, when “1” is written to the zeroth bit of the control register “SIOInterruptClear” in the state where the interrupt request signal IRQ6 is asserted, the interrupt request signal IRQ6 is negated.

The control register “SIOInterruptEnable” of FIG. 21(c) is used to permit, by setting “1” to the zeroth bit thereof, an interrupt issued when the data transmission from the general purpose parallel/serial conversion port 91 is completed and an interrupt issued when the data reception of a predetermined number of bytes is completed by the general purpose parallel/serial conversion port 91.

The control register “SIOStatus” of FIG. 21(d) is used to indicate, by the zeroth bit, whether or not there is an interrupt issued when the data reception of the predetermined number of bytes is completed, such that if the first bit is “0” it indicates that the general purpose parallel/serial conversion port 91 is performing neither transmission nor reception and if the first bit is “1” it indicates that transmission or reception is in progress. The second bit indicates whether the data transmission is completed or not completed.

The control register “SIOControl” of FIG. 21(e) is used to indicate, by the zeroth bit, the direction of data transmission (reception mode/transmission mode) and indicate, by the first bit, whether data transmission and reception is disabled/enable. The control register “SIOBufferTopAddress” of FIG. 21(f) is used to set the start address SAD of the transmitting and receiving buffer SRB for storing transmission and reception data. The control register “SIOBufferEndAddress” of FIG. 21(g) is used to set the end address EAD of the transmitting and receiving buffer SRB for storing transmission and reception data.

The control register “SIOByteCount” of FIG. 21(h) is used to set the number of bytes of transmission data when data transmission is performed, and set the number of bytes of reception data when data reception is performed such that an interrupt is issued each time when receiving the set number of bytes of reception data. The control register “SIOCurrentBufferAddress” of FIG. 21(i) is used to indicate the current read/write address pointed to by the pointer RWP of the transmitting and receiving buffer SRB.

By the way, as has been discussed above, since the buffer for serial data transmission and reception, i.e., the transmitting and receiving buffer SRB is defined in the main RAM 25 which is shared with the other function units such as the CPU 5, and the main RAM 25 can be directly accessed from the general purpose parallel/serial conversion port 91 without the aid of the CPU 5 so that large size data can be easily transmitted and received, the CPU 5 can acquire received data and set transmission data only by accessing the main RAM 25 and thereby it is possible to effectively handle transmission and reception data to/from the CPU 5. Moreover, in the case where the transmission and reception of serial data is not performed, the area of the transmitting and receiving buffer SRB can be used by another function unit for another purpose. Furthermore, since storing the received data in the transmitting and receiving buffer SRB is started from the time point at which the received data is first changed after setting the start of receiving data, invalid received data preceding the first valid received data is not stored in the main RAM 25 and thereby it is possible to effectively perform the process of the received data by the CPU 5.

Also, in the case of the present embodiment, since one bit received just before the time point at which the first received data SDR is changed is stored in the transmitting and receiving buffer SRB as illustrated in FIG. 18, it is possible to perform the process of detecting the start bit of a packet by the CPU 5 with a higher degree of accuracy.

Furthermore, in the case of the present embodiment, the general purpose parallel/serial conversion port 91 automatically stops data transmission without receiving an instruction when a predetermined amount of data is completely transmitted. Because of this, uncertain data stored in the transmitting and receiving buffer SRB is not accidentally transmitted.

Furthermore, in the case of the present embodiment, the start address SAD and end address EAD of the area of the transmitting and receiving buffer SRB is set to arbitrary values by the CPU 5 as physical addresses of the main RAM 25. As has been discussed above, since the position and size of the area of the transmitting and receiving buffer SRB can be freely set, it is possible to use the main RAM 25 effectively from the view point of the overall system by assigning an area of a necessary and sufficient size to the transmitting and receiving buffer SRB, and using the remaining area for the other function units.

Furthermore, in the case of the present embodiment, the value of the pointer RWP is incremented each time data is transmitted or received, and reset to the start address SAD when the value of the pointer RWP reaches the end address EAD. In this way, the transmitting and receiving buffer SRB is used as a ring buffer.

Meanwhile, the present invention is not limited to the embodiments as described above, but can be applied in a variety of aspects without departing from the spirit thereof, and for example the following modifications may be effected.

(1) In the above description, only the IPL 35, the CPU 5 and the DMAC 4 can issue an external bus access request to the external memory interface 3. However, it is possible to modify the system in order that more function units can issue external bus access requests.

(2) In the above description, only the CPU 5, the RPU 9 and the SPU 13 can issue a DMA transfer request to the DMAC 4. However, it is possible to modify the system in order that more or fewer function units can issue DMA transfer requests. In this case, there are the same number of the request buffers provided in the DMAC 4 as there are the function units capable of issuing DMA transfer requests. Also, the number of entries in the DMA request queue 45 is not limited to four.

(3) In the above description, the address space of the external bus 51 is divided into two areas. However, it is possible to divide the address space into three or more areas. In this case, there are the same number of pairs of the memory type register and the access timing register as there are such areas.

(4) In the above description, there are three memory interfaces 40 to 42. However, it is possible to provide two or one, or four or more interfaces. Also, while a NOR interface, a page mode supporting NOR interface and a NAND interface are supported as memory interfaces, the type of memory interface is not limited thereto.

(5) In the above description, only the CPU 5 takes control of the other function units by the use of the I/O bus 27. However, it is possible to modify the system in order that a plurality of function units can take control of other function units.

(6) In the above description, the EBI priority level table is fixed. However, it is possible to switch among a plurality of different EBI priority level tables in accordance with whether or not predetermined conditions are met. On the other hand, while one of the two priority level tables is switchingly used, it is possible to switchingly use one of three or more priority level tables.

(7) While only the CPU 5 can issue a request for data decompressing DMA transfer in the above description, it is not limited thereto but it is possible to modify the system in order that another function unit can issue a request for data decompressing DMA transfer. While the present invention has been described in terms of embodiments, it is apparent to those skilled in the art that the invention is not limited to the embodiments as described in the present specification. The present invention can be practiced with modification and alteration within the spirit and scope which are defined by the appended claims. Accordingly, the description of this application is thus to be regarded as illustrative instead of limiting in any way on the present invention.

1. A multiprocessor capable of accessing an external bus, comprising:
a plurality of processor cores each of which is operable to perform an arithmetic operation;
an internal memory which is shared by said plurality of processor cores;
a direct memory access controller operable to perform arbitration among direct memory access transfer requests issued by part or all of said processor cores, and perform direct memory access transfer between said internal memory and an external memory which is connected to the external bus; and
an external memory interface operable to perform arbitration among requests for using the external bus issued by part or all of said processor cores and said direct memory access controller, and permit one of said processor cores and said direct memory access controller to access the external bus.

2. The multiprocessor as claimed in claim 1 wherein said direct memory access controller comprises:
a plurality of buffers each of which is operable to store the direct memory access transfer request issued from a corresponding one of said processor cores;
an arbitration unit operable to perform arbitration among a plurality of the direct memory access transfer requests which are output from a plurality of said buffers, and output one of the direct memory access transfer requests;
a queue operable to hold a plurality of the direct memory access transfer requests, and output the direct memory access transfer requests output from said arbitration unit in the order of reception; and
a direct memory access transfer execution unit operable to execute direct memory access transfer in response to the direct memory access transfer request output from said queue.

3. The multiprocessor as claimed in claim 1 wherein said external memory interface performs arbitration in accordance with a priority level table in which are determined priority levels of said processor cores and said direct memory access controller which can issue requests for using the external bus, and
wherein, as the priority level table, there is a plurality of priority level tables each of which has different priority level information each other.

4. The multiprocessor as claimed in claim 3 wherein said external memory interface performs the arbitration by switching the priority level table when a predetermined condition is satisfied.

5. The multiprocessor as claimed in claim 4 wherein the predetermined condition is that a predetermined processor core of said processor cores or said direct memory access controller waits for a predetermined time after issuing a request for using the external bus.

6. The multiprocessor as claimed in claim 5 wherein said external memory interface includes a control register which can be accessed by at least one of said processor cores, and switches the priority level table under an additional condition that the control register is set to a predetermined value by the at least one of said processor cores.

7. A multiprocessor capable of accessing an external bus, comprising:
a plurality of processor cores each of which is operable to perform an arithmetic operation; and
an external memory interface operable to perform arbitration among requests for using the external bus issued by part or all of said processor cores, and permit one of said processor cores to access the external bus,
wherein said external memory interface includes a plurality of different memory interfaces, and wherein one of the plurality of different memory interfaces is selected to access, through the memory interface as selected, an external memory which is connected to the external bus and belongs to a type supported by the memory interface as selected.

8. The multiprocessor as claimed in claim 7 wherein an address space of the external bus is divided into a plurality of areas each of which can be set in terms of the type of the external memory, and
wherein said external memory interface selects the memory interface which supports the type of the external memory allocated for the area including the address issued by the processor core that is permitted to access the external bus, and accesses the external memory through the memory interface as selected.

9. The multiprocessor as claimed in claim 8 wherein said external memory interface includes a plurality of first control registers corresponding respectively to the plurality of areas,
wherein at least one of said processor cores can access the plurality of first control registers,
wherein, by setting a value in one of the first control registers through the at least one of said processor cores, a type of the external memory can be allocated for the area corresponding to the one of first control registers.

10. The multiprocessor as claimed in claim 7 wherein an address space of the external bus is divided into a plurality of areas each of which can be set in terms of the data bus width of the external bus.

11. The multiprocessor as claimed in claim 10 wherein said external memory interface includes a plurality of second control registers corresponding to the plurality of areas, wherein
the plurality of second control registers can be accessed by at least one processor core, and wherein
by setting a value in one of the second control registers through the at least one processor core, a data bus width of the external bus can be set in the area corresponding to the one of second control registers.

12. The multiprocessor as claimed in claim 7 wherein an address space of the external bus is divided into a plurality of areas each of which can be set in terms of a timing for accessing the external memory.

13. The multiprocessor as claimed in claim 12 wherein said external memory interface includes a plurality of third control registers corresponding respectively to the plurality of areas,
wherein at least one of said processor cores can access the plurality of third control registers, and
wherein, by setting a value in one of the third control registers through the at least one of said processor cores, the timing for accessing the external memory can be set for the area corresponding to the one of the third control registers.

14. The multiprocessor as claimed in claim 7 wherein said external memory interface includes a fourth control register which can be accessed by at least one of said processor cores,
wherein the boundary of the areas can be set by setting a value in the fourth control register through the at least one of said processor cores.

15. A multiprocessor comprising:
a plurality of processor cores each of which is operable to perform an arithmetic operation;
an internal memory which is shared by said plurality of processor cores;
a first data transfer path through which data is transferred between said processor cores and said internal memory; and
a second data transfer path through which one of said processor cores performs data transfer for controlling another processor core.

16. The multiprocessor as claimed in claim 15 wherein the said processor core that controls the another processor core by the use of the second data transfer path is a central processing unit capable of decoding and executing program instructions.

17-31. (canceled)
